(19) United States
(12) Patent Application Publication
(10) Pub. No.: US 2013/0218766 A1
(43) Pub. Date: Aug. 22, 2013

(54) Mobile Transactions and Payments

(71) Applicant: Michael Mueller, San Diego, CA (US)

(72) Inventor: Michael Mueller, San Diego, CA (US)

(21) Appl. No.: 13/590,186

(22) Filed: Aug. 20, 2012

Related U.S. Application Data
(60) Provisional application No. 61/524,769, filed on Aug. 18, 2011.

(51) Int. Cl. G06Q 20/32

(52) U.S. Cl. CPC G06Q 20/32
USPC 705/42

(57) ABSTRACT

The present invention includes an apparatus and method for identifying and connecting mobile devices by scanning a tag associated with a location, place, or other information.

### SUMMARY OF THE INVENTION

The present invention includes an apparatus and method for identifying and connecting mobile devices by scanning a tag associated with a location, place, or other information. Application claims priority to application No. 61/524,769.

### BACKGROUND

Identification tags are currently used in a variety of mediums, from tracking wild animals to surgical sponges in the operating room. Identification tags are most commonly used in animal husbandry. They are very simple to install/inject inside the body of animals, thus helping to keep a track on them. The installed RFID tags give information about the age, vaccinations and health of the animals.

Another common form of use of identification tags is in the supply chain management business. Identification tag systems play a key role by managing updates of stocks, transportation and logistics of the product. However, in the consumer product field the use of identification tag is limited as consumers are apprehensive about their privacy when they purchase products with identification tags. Additionally, the installation of the tag can be expensive and reading tags installed in liquids and metal products are difficult to read by identification tag readers.

While identification tags are increasingly used with consumer products, such as for clothing line, identification tags on consumer products have not been uniformly accepted as a because of cost and functionality limitations. One such example for lack of commercial acceptance stems from the cost of installation of such identification on each product. Small and medium scale enterprises find it costly to use it in their firms and offices. Further, it is difficult for an identification reader to read the information in case of identification tags installed in liquids and metal products. The problem is that the liquid and metal surfaces tend to reflect the radio waves, which makes the tags unreadable. The tags have to be placed in various alignments and angles for taking proper reading. Accordingly, it would be desirable to provide an unobtrusive and cost-effective package that includes relatively high data capacity, security and re-write capability.

### BRIEF DESCRIPTION OF DRAWINGS

FIG. 1 is a block diagram of a component configuration for tag and mobile device interactions, according to an exemplary embodiment.

FIG. 2a through 2e are block diagrams of component configurations for tag and device interactions, according to exemplary embodiments.

FIG. 3a through 3c are flow charts illustrating process for tag and device interactions, according to exemplary embodiments.

FIG. 4 is a flow chart of a process for tag programming or associating, according to exemplary embodiment.

FIG. 5a through 5c are block diagrams of component configurations with virtual/electronic interactions, in-person interactions, and payments for tag and device interactions, according to exemplary embodiments.

FIG. 6a through 6b are flow charts of processes for user authentication in tag and device interactions, according to exemplary embodiments.

FIG. 7a through 7b are block diagrams of component configurations for user pre-approval in tag and device interactions, according to exemplary embodiments.

FIG. 7c through 7e are flow charts of processes for user pre-approval in tag and device interactions, according to exemplary embodiments.

FIG. 8 is a block diagram of a component configuration for tag and mobile device interactions, according to exemplary embodiments.

FIG. 9a through 9c are block diagrams of component configurations for accessing prior tag data, according to exemplary embodiments.

FIG. 10a through 18c are diagrams of component configurations and processes according to exemplary embodiments.

### DESCRIPTION OF THE INVENTION

The present invention is illustrated by way of example and not by way of limitation in the figures of the accompanying drawings in which like references indicate similar elements. The invention is not limited to the referenced embodiments in this disclosure. While specific implementations are discussed, it is understood that this is done for illustrative purposes only. A person skilled in the relevant art will recognize that other components and configurations may be used without departing from the scope and spirit of the invention.

In the following description, numerous examples and embodiments are set forth to provide a thorough description of the invention. It will be apparent, however, to those skilled in the art that the invention may be practiced using any similar type of component(s) used in the illustrations. In other instances, well-known features have not been described in detail so as not to obscure the invention. Possible components include tags, mobile devices, systems and networks that one skilled in the relevant art would recognize as such.

Although a diagram may depict components as logically separate, such depiction is merely for illustrative purposes. It will be apparent to those skilled in the art that the components portrayed can be combined or divided into separate software, firmware, and/or hardware components. Furthermore, it will be apparent to those skilled in the art that such components can execute on the same computing device or can be distributed among different computing devices connected by one or more networks or other suitable communication means, regardless of how the components are combined or divided. Even though only one or two combinations of components of the present invention are illustrated in the figures, any number of combinations of components are foreseeable and envisioned.

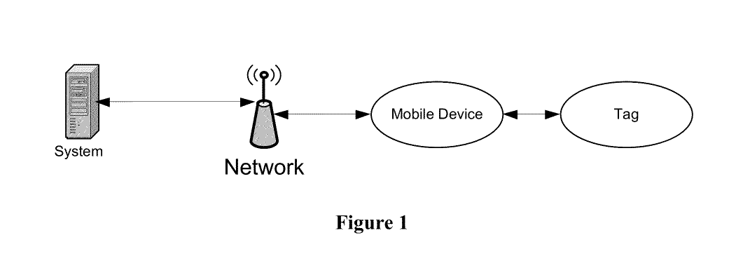

FIG. 1 is an illustration of an apparatus in which a tag containing information in the form of print, program, or other means transfers the information to a mobile device. The transfer may occur by the mobile device user manually imputing tag printed information into the mobile device, taking a picture of the tag with the mobile device, or scanning the tag. If the tag is a radio frequency identification (RFID) tag, it may be scanned with a near field communication enable device (NFC). The tag information transfer enables/creates a connection between the mobile device and a network. The network is connected to systems, other electronic devices, and other mobile devices. The connection may be wired or wireless. The system may be a database, website, server, or other similar means. The preferred configuration is with a RFID tag and a mobile device that have NFC capabilities.

A tag for the purposes of this disclosure is intended to mean and include but not be limited to radio frequency identification (RFID), printed code, quick response (QR) code, and barcode. However, those of ordinary skill in the art may appreciate that a tag may also refer to other suitable substitutes for displaying, communicating, transferring information or data and other uses in this disclosure.

A mobile device for the purposes of this disclosure is intended to mean and include but not be limited to portal electronic mobile devices that allow a user to access, view and send data and information. Examples of mobile devices include cellular phones, tablets, laptops, netbooks, personal digital assistants, smartphones, barcode scanners, radio frequency scanners, and smart card scanners. Input methods for such mobile devices may include touch screens, keyboards, other buttons, voice recognition, and other like input means.

Scan or scanning for the purposes of this disclosure includes but is not limited to identifying, gathering, collecting, exchanging, using, or transferring data, content, or information. Examples of scanning include but are not limited to: using beams of light or electrons to reproduce or sense and subsequently transmit and image; searching stored data for data; digitally encode with a scanner; undergoing electronic scanning; gathering or accumulating data, information, or content; call for and obtain data; and manually input displayed data into a device.

A network for the purposes of this disclosure includes but is not limited to internet, intranet, and extranet. The types of networks include personal area networks (PAN), local area networks (LAN), metropolitan area networks (MAN), wide area networks (WAN), wireless networks, and like device networks.

A device network includes but is not limited to a collection of devices that are interconnected by communication channels that facilitate communications and allow sharing of resources and information among the devices.

Wireless networks may include wireless PAN, wireless LAN, wireless MAN, wireless WAN, Global System for Mobile Communication (GSM), Personal Communication Service (PCS), Digital Advanced Mobile Phone Service (DAMPS), and other wireless device networks. Examples of wireless technologies include but are not limited to mobile broadband, 4G, 3G, Wi-Fi, Zigbee, Bluetooth, and routers. Networks technologies may include cables, optical fiber, and various wireless technologies, such as routers.

A system for the purposes of this disclosure is intended to mean and include but not be limited to a server, database, website, application program interface, or a collection of these components.

A server for the purposes of this disclosure is intended to mean and include: a computer program running as a service that serves the needs or requests of other programs, such computer program need not only run on one computer; a computer that runs one or more services for other programs, computers, or devices; or a software and hardware system, such as a database server, file server, web server, enterprise server, mail server, or print server. A server may provide servers across one or more networks.

A database for the purposes of this disclosure is intended to mean and include an organized collection of data or content. Database content includes bibliographic, document-text, statistical, multimedia objects, and other like content. A database may be used for attendance, document storage, accounting, music, banking and payments, sales, and other like content. A database when referred to in this disclosure may be comprised of small databases. A Database Management System (DBMS) may be used to access, change or store data associated with the database. Examples of DBMSs include Oracle® DBMS, SQL Server, DB2.

A website for the purposes of this disclosure is intended to mean and include but not be limited to one or more web pages containing digital text, images, videos, document or other digital assets. A website is general hosted by at least one web server and associable through at least one network. A web page generally contains content in a suitable programming language. A website may utilize encryption and other security measure to protect such content. An application is generally used by a user to access and interact with the content.

An application programming interface (API) for the purposes of this disclosure is intended to mean and include but not be limited to a set of rules and specifications that software programs can follow to communicate with one another and enables users to interact with other humans, programs, or devices.

The embodiment in FIG. 1 and the other embodiments of this disclosure may also include a security component. A security component for the purposes of this disclosure is intended to mean and include but not be limited to programs, software, hardware, devices, methodology, used to secure devices, computers, systems, networks or other means securing and protecting information, data, content, and property from intrusion. Examples of security components include dongles, kernels, memory management units, secure coding, access control lists, capability-based security, applications, and cloud computing security programs.

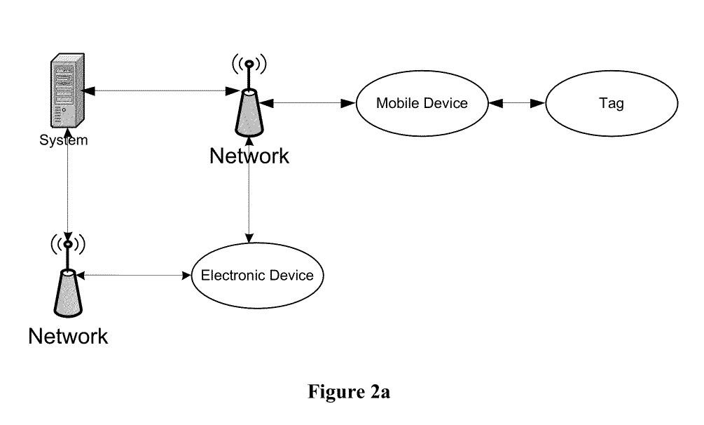

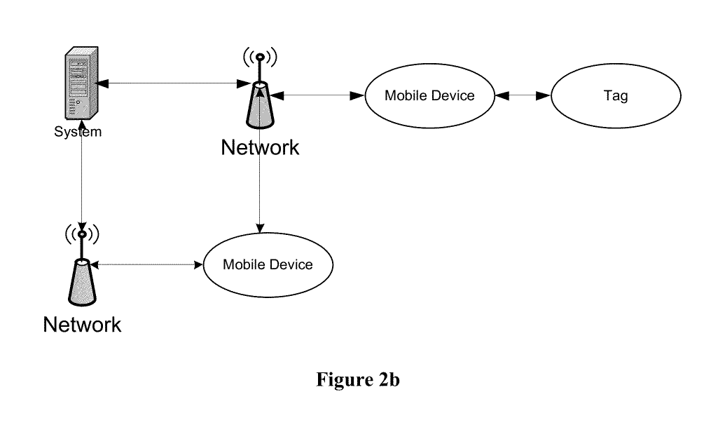

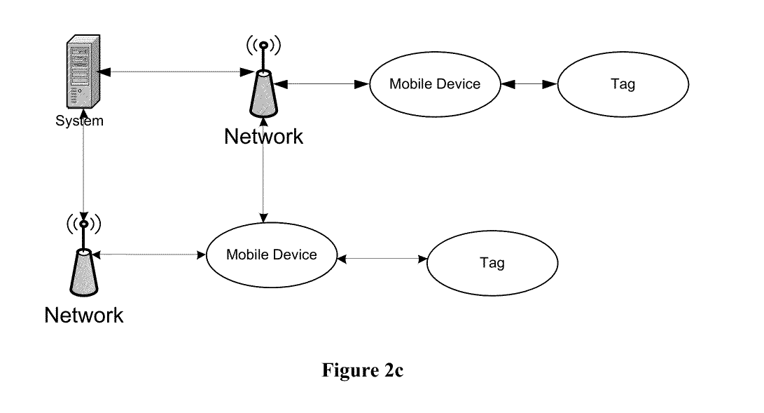

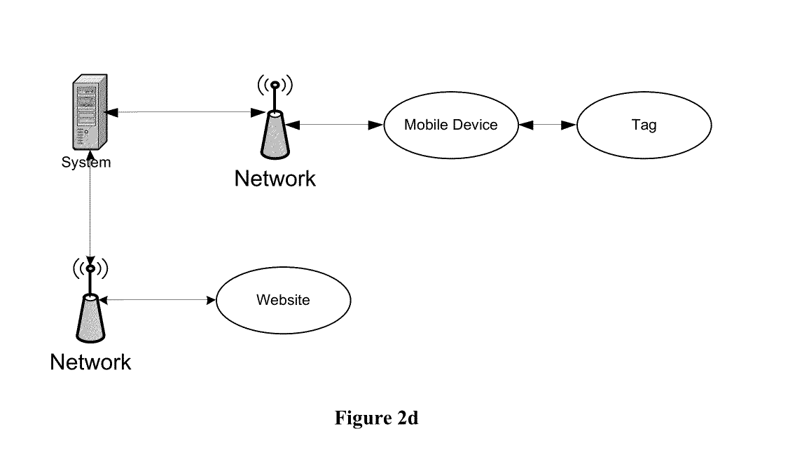

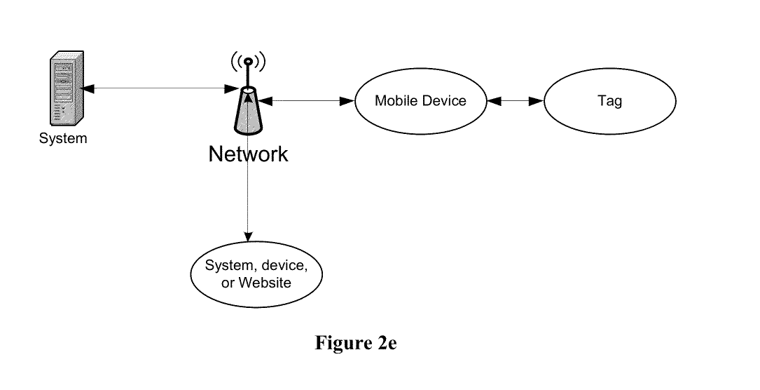

FIG. 2a illustrates an apparatus in which a mobile device is associated with a tag, and the mobile is connected to a network. Through at least one network, the mobile device is connected to a system (server, website, API, etc.) and the mobile device is connected to another electronic device (computer, server, phone, etc.). However, those skilled in the art may recognize that a plurality of mobile devices may be used and those skilled in the art may appreciate that a tag may also refer to other suitable substitutes for the purpose of this disclosure.

An electronic device for the purposes of this disclosure is intended to mean and include but not be limited to any at least one electronic component that depends on the principles of electronics and uses the manipulation of electronic flow for its operation. Examples of electronic devices include display, video display, answering machine, dongle, router, smartphone, phone, cellular phone, global positioning system, clock, computer, server, workstation, tablet, light, radio, antenna, transmitter, and receiver.

An example of a tag and mobile device interaction apparatus as illustrated in FIG. 2a is a RFID tag that is scannable by an NFC enabled tablet. The tablet is connected to a Wi-Fi network. The Wi-Fi network is connected to a database containing content and applications. The database is connected to a computer through a LAN connection. Using this apparatus, the tablet is able to access and connect to the wireless network and database content after scanning the RFID tag. After establishing the connection, the location of tablet (known by the tag location) is communicated to the computer.

FIG. 2b illustrates a configuration in which a mobile device is associated with a tag, and the mobile device is connected to a network. Through the network or a plurality of networks, the mobile device is connected to a system (server, website, API, etc.) and the mobile device is connected to another electronic device (computer, server, phone, etc). However, those skilled in the art may use a configuration that includes multiple mobile devices and/or multiple networks and/or multiple other electronic devices. However, those skilled in the art may appreciate that a tag may also refer to other suitable substitutes for the purpose of this disclosure.

An example of a tag and mobile device interaction apparatus as illustrated in FIG. 2b is a RFID tag that is scannable by an NFC enabled tablet. The tablet is connected to a Wi-Fi network. The Wi-Fi network is connected to a database containing content and applications. The database is connected to a smartphone through a 4G network connection. Using this apparatus, the tablet is able to access connect to the wireless network and database content after scanning the RFID tag. After establishing the connection, the location of tablet (known by the tag location) is communicated to the smartphone.

FIG. 2c illustrates an apparatus in which two mobile devices are associated with one tag each, and each mobile device is connected to at least one network. Through the network or a plurality of networks, the mobile device is connected to a system (server, website, API, etc.) and the first mobile device is connected to a second mobile device. The second mobile device is associated with a second tag. However, those skilled in the art may appreciate that a tag may also refer to other suitable substitutes for the purpose of this disclosure.

An example of a tag and mobile device interaction apparatus, as illustrated in FIG. 2a, is a RFID tag that is scannable by an NFC enabled tablet. The tablet is connected to a Wi-Fi network. The Wi-Fi network is connected to a database containing content and applications. The database is connected to a NFC enabled smartphone through a 4G network connection or a Wi-Fi network. Using this apparatus, the tablet is able to access and connect to the wireless network and database content after scanning the RFID tag. After establishing the connection, the location of mobile device (known by the tag location) is communicated to the smartphone. Furthermore, the smartphone is able to access and connect to the wireless network and database content after scanning the RFID tag. After establishing the connection, the location of smartphone (known by the tag location) is communicated to the tablet.

FIG. 2d illustrates an apparatus in which a mobile device is associated with a tag, and the mobile device is connected to a network. Through the network or a plurality of networks, the mobile device is connected to a system (server, website, API, etc.) and the mobile device is connected to a website or other data source/interface (API, etc). However, those skilled in the art may appreciate that a tag may also refer to other suitable substitutes for the purpose of this disclosure.

FIG. 2e illustrates an apparatus in which at least one mobile device is associated with at least one tag, and the mobile is connected to at least one network. Through the network or a plurality of networks, the mobile device is connected to a system (server, website, API, etc.) and the mobile device is connected to a website or other data source/interface (API, etc). However, those skilled in the art may appreciate that a tag may also refer to other suitable substitutes for the purpose of this disclosure.

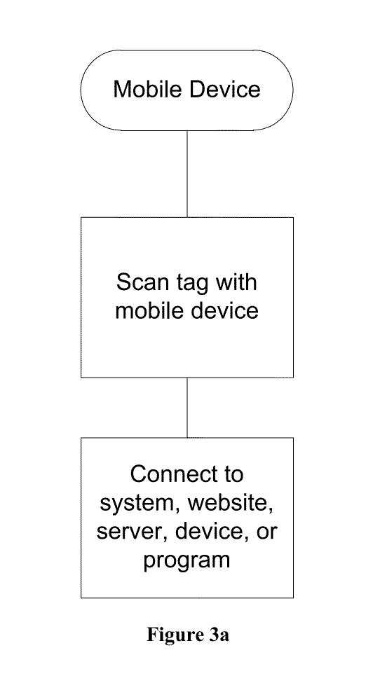

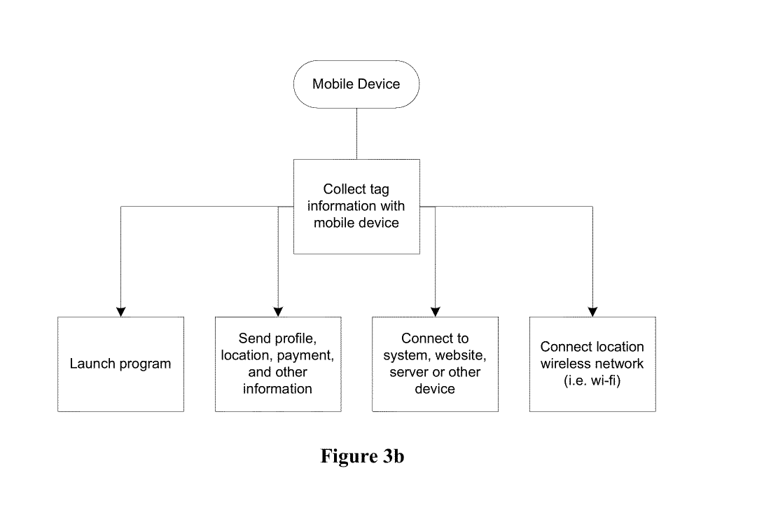

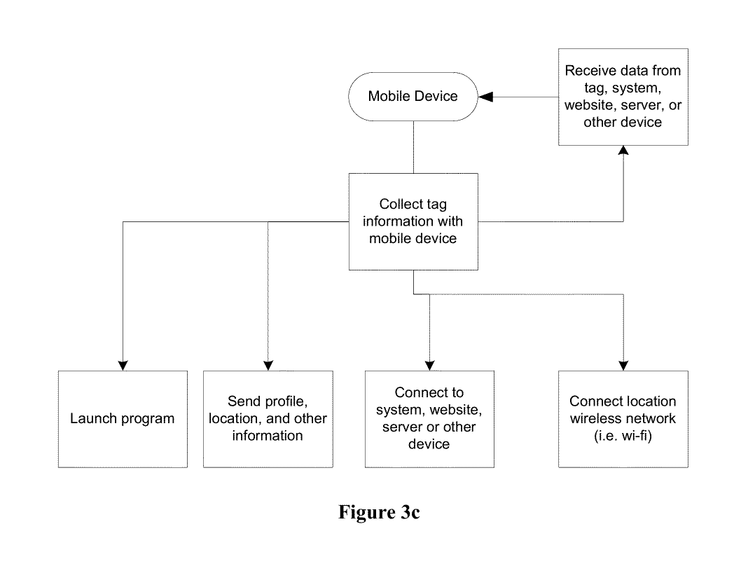

FIG. 3a illustrates a process in which a mobile device connects to a system, website, server, or other electronic device by scanning or collecting information from a tag. However, those skilled in the art may appreciate that a tag may also refer to other suitable substitutes for the purpose of this disclosure.

FIG. 3b illustrates a process in which a mobile device collects information from a tag and simultaneously, sequentially, or randomly performs a variety of functions. When the mobile device collects information from the tag, the device performs one or more functions. The possible functions include connect to a network, launch an application, download data, send information, initiate payment, and other foreseeable and like occurrences. However, those skilled in the art may appreciate that a tag may also refer to other suitable substitutes for the purpose of this disclosure.

FIG. 3c illustrates a process in which a mobile device receives additional data after a first scan of the tag. The additional data being received by the mobile device is the result of a signal or connection from the initial data collection. However, those skilled in the art may appreciate that a tag may also refer to other suitable substitutes for the purpose of this disclosure.

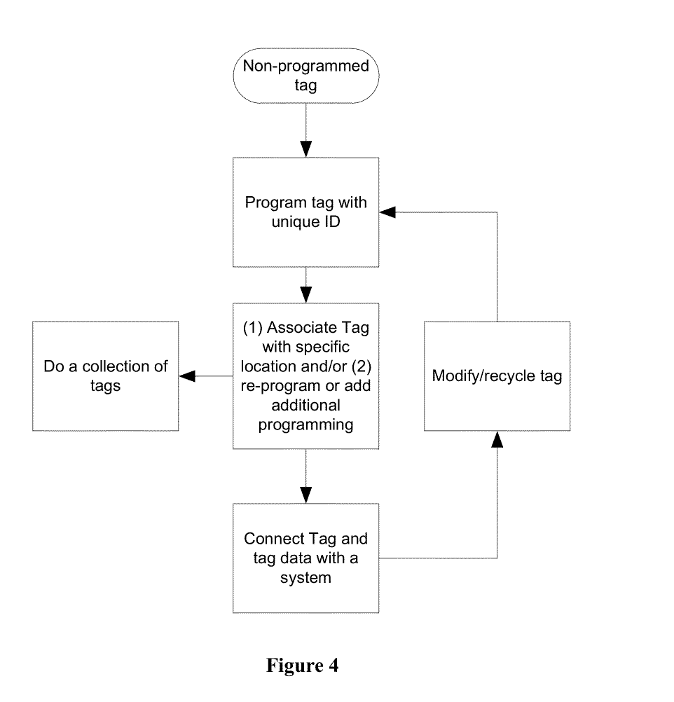

FIG. 4 illustrates a process in which a tag is programmed, associated, un-programmed, or unassociated. A device or apparatus inputs and/or creates the information on the tag. Examples of such inputting devices include a printer for computer and printer for creating and printing a QR code or a NFC enabled device that can program an RFID tag. These examples are for explanatory purposes and non-exhaustive. Multiple tags may be used to create a collection of similar or identical tags. An example of a collection of tags is a plurality of tags used at each seat of a table, in which each tag corresponds to a particular seat or seats at the table. It is possible for a tag to be pre-programmed and this programming data is used to associate and identify the tag within a system. Tag association may include but is not limited to location, person, picture, device, goods, or services.

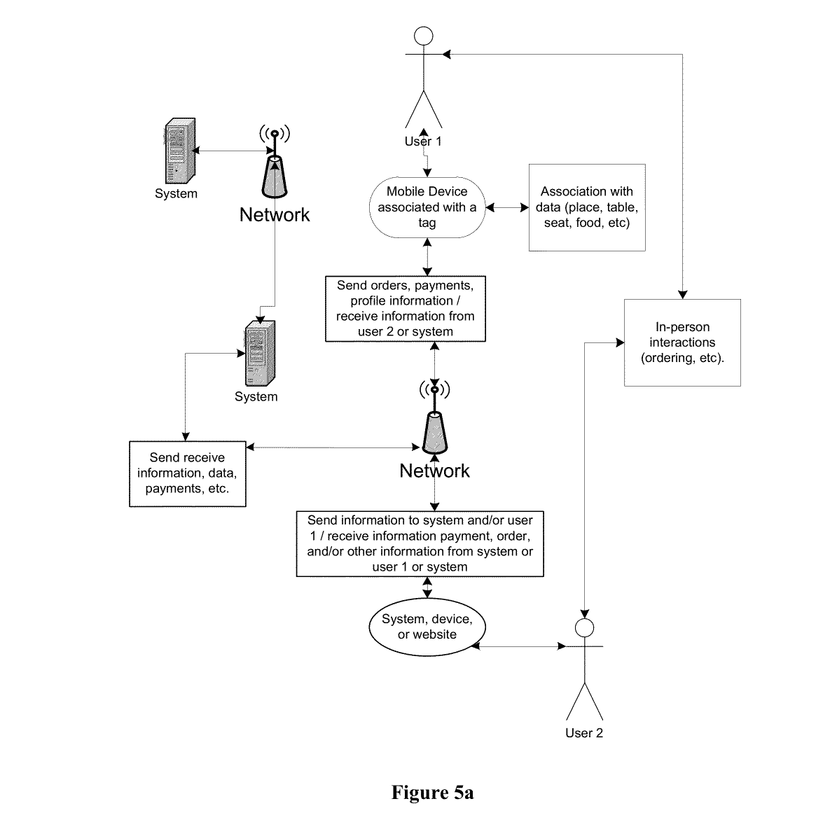

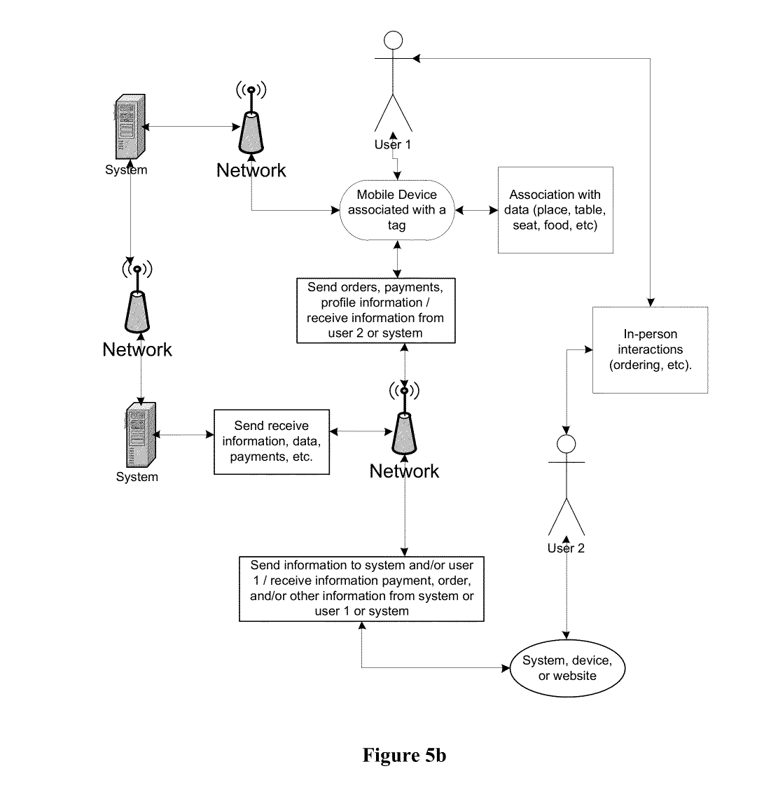

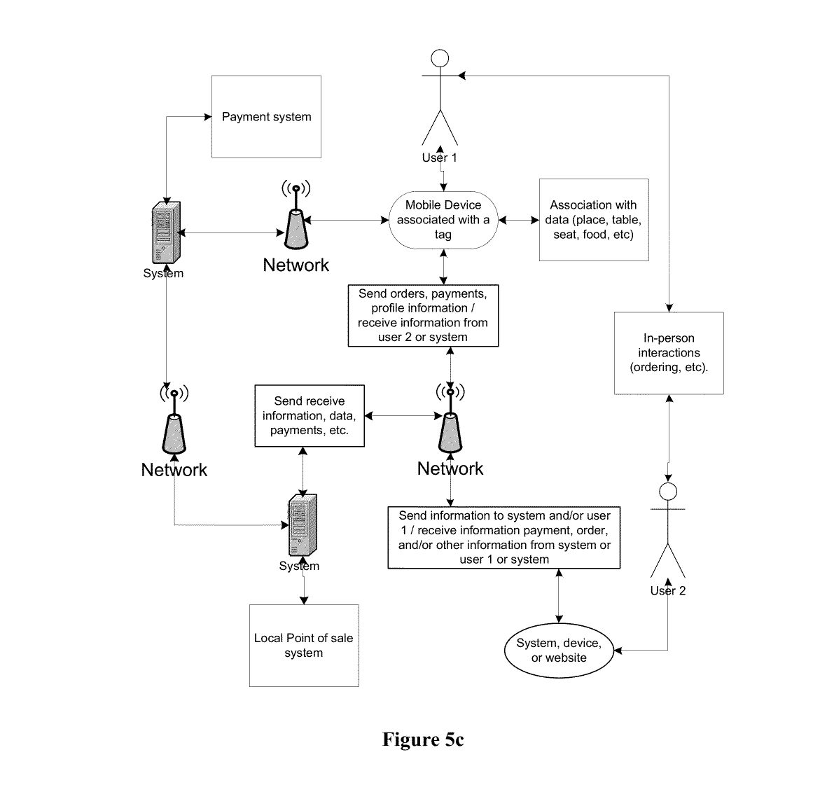

FIG. 5a is an illustration in which a plurality of networks and systems along with in-person interactions to enhance tag and mobile device interactions.

An example of the embodiment in FIG. 5a is a restaurant patron with a NFC-enabled mobile device interacting with restaurant staff and devices. The patron sits down at a table that has an RFID tag. The patron then scans the RFID tag with the NFC mobile device. The mobile device connects with a Wi-Fi network and the patron is able to send profile information to the restaurant, access menu information, and make requests to the restaurant system and staff for food or beverage. A restaurant staff member is able to view information from the patron and send information to the patron. The patron's location at the table is known to the restaurant because the tag is programmed to be associated with the patron's table location. A restaurant staff member is able to bring food and drink to the patron, take orders in-person and input them into the staff member's device. The staff member is able to send a payment request to the patron and the patron is able to send a payment to the restaurant through the tag and mobile device connection.

Another embodiment of the present invention is an apparatus and method for monitoring testing on mobile devices. In this embodiment, students with NFC enable devices scan RFID tags corresponding to seating locations in a classroom. With an electronic device, the student takes a quiz or exam. The number and inputs of each student is sent to a system and electronic device. The student information sent to the electronic device is readable by an instructor/proctor. Therefore, the instructor/proctor is able to view a live seating chart with each identified student and each student's inputs. This apparatus and method is used for monitoring and analysis. If students have similar inputs with respect to time and answers, the instructor or proctor can view the location of the students, determined by the tag scanning, to determine if cheating has occurred.

Another embodiment of the present invention is an apparatus and method for parking structures. In this embodiment, each parking space has a corresponding RFID tag (or QR code tag) affixed near each parking space. When a person parks in a space, the person scans the tag, connects to a parking system, and selects the parking time and rate and may input information such as name and/or vehicle license plate. When the person leaves the space, the user scans the RFID tag and sends payment to the parking system. The parking system logs the person's information, time parked, and payment. The parking structure may do an electronic or visual check of the parking spaces with cars in the spaces to determine whether all cars have scanned the tag to register for the parking spot. Furthermore, if a person forgets to scan the tag upon leaving the parking space, the parking system (or parking employee) can send a notification to the person once the parking space have been identified as available even though the person is still registered for the space.

FIG. 5b is an illustration of the present invention, which includes a mobile device, which is associated with a tag and connected to a network, connects with at least one other network. The connections may be simultaneous, sequential, alternating randomized or any other temporal pattern of connections.

An example of the embodiment in FIG. 5b is a mobile device first connecting with a Wi-Fi network after scanning a tag that earlier or later also connected to a second network, such as a 3G or 4G connection from a wireless carrier. An example of three or more networks configured in this embodiment is a mobile device that is already connected to a Wi-Fi network, a 3G network and a Bluetooth network later connects with a 4G network while simultaneously disconnecting the 3G network where the 3G and 4G connections are randomized but not simultaneous. FIG. 5b is an illustration of the present invention facilitating payments. In this embodiment of the invention, the mobile device may have a separate network connection via wireless carrier or other like means as well as a connection established through the tag scanning. The network via tag scanning may or may not be an intranet network.

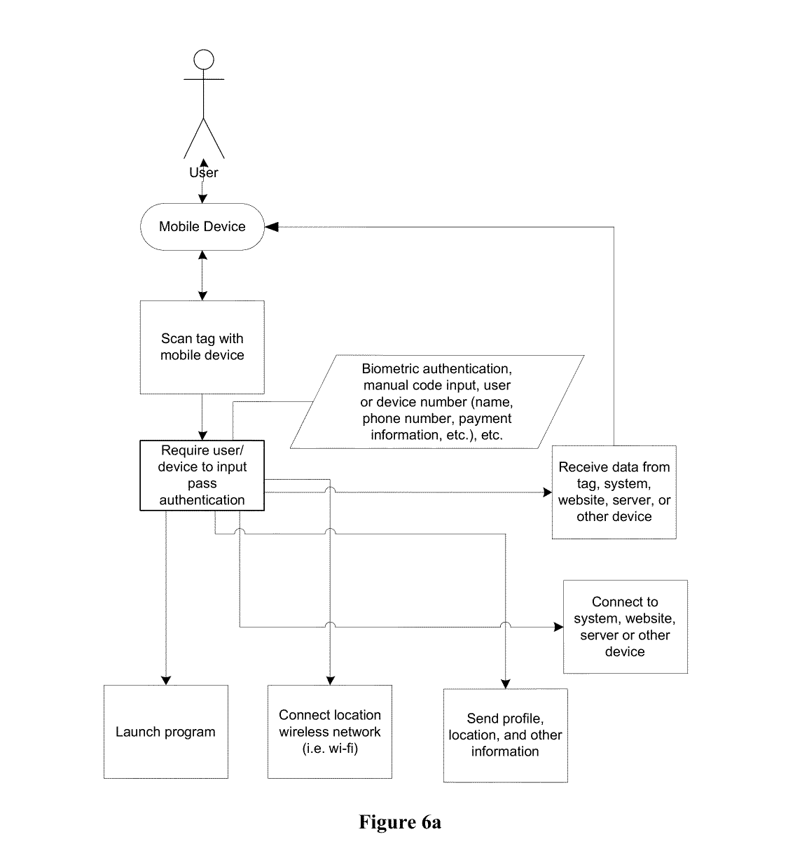

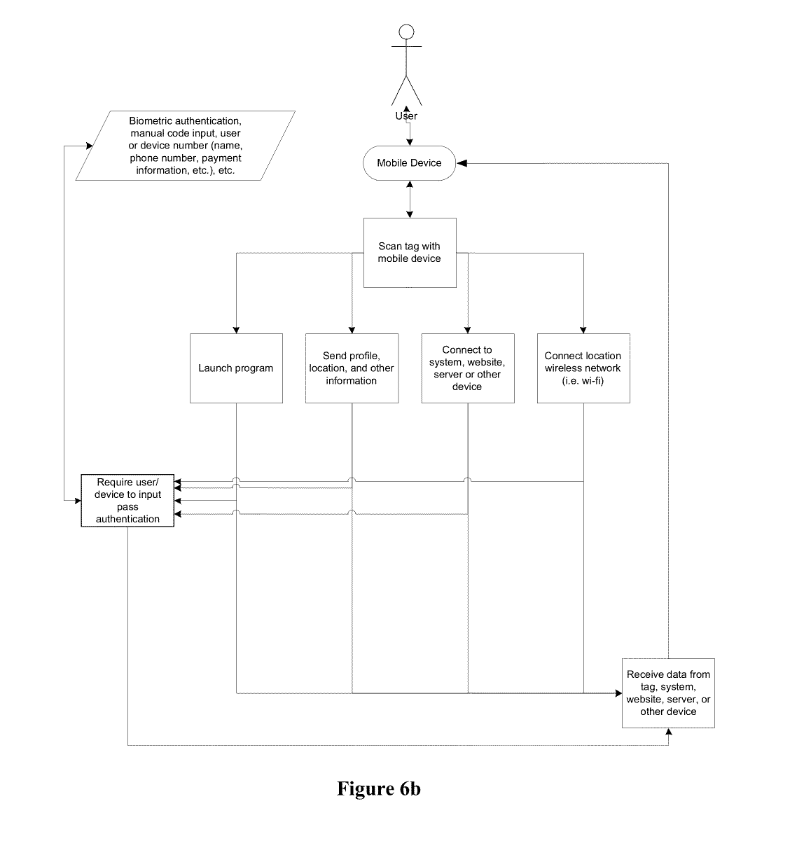

FIG. 6a is an illustration of an authentication process in which the mobile device must have a password or other means of security clearance in order to access additional tag data and or perform additional functions. After authentication, the mobile device is able to send and receive data.

An example of such a process is a mobile device user scanning a RFID tag and upon scanning, the user is required to manually input a code that is printed on the RFID tag. After inputting the printed code, the user, using the mobile device, is able to perform additional functions, such as the ones shown in FIG. 6a.

FIG. 6b is an illustration in which authentication is required after the tag is scanned and the mobile device is then connected to another network, system, and/or process. After authentication, the mobile device is able to send and receive data.

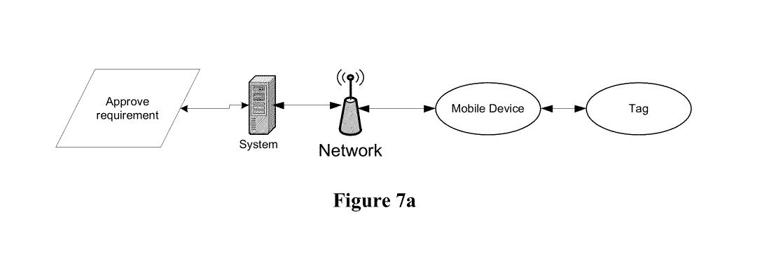

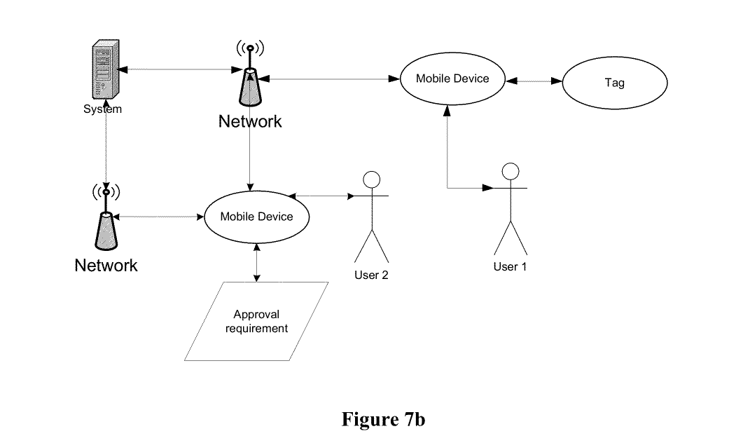

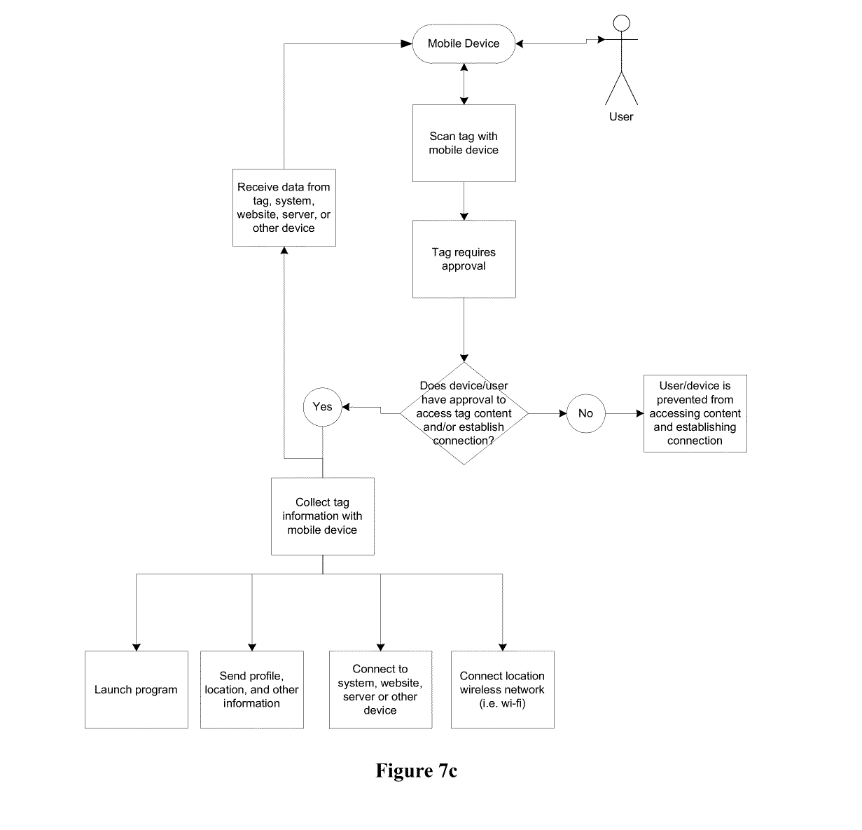

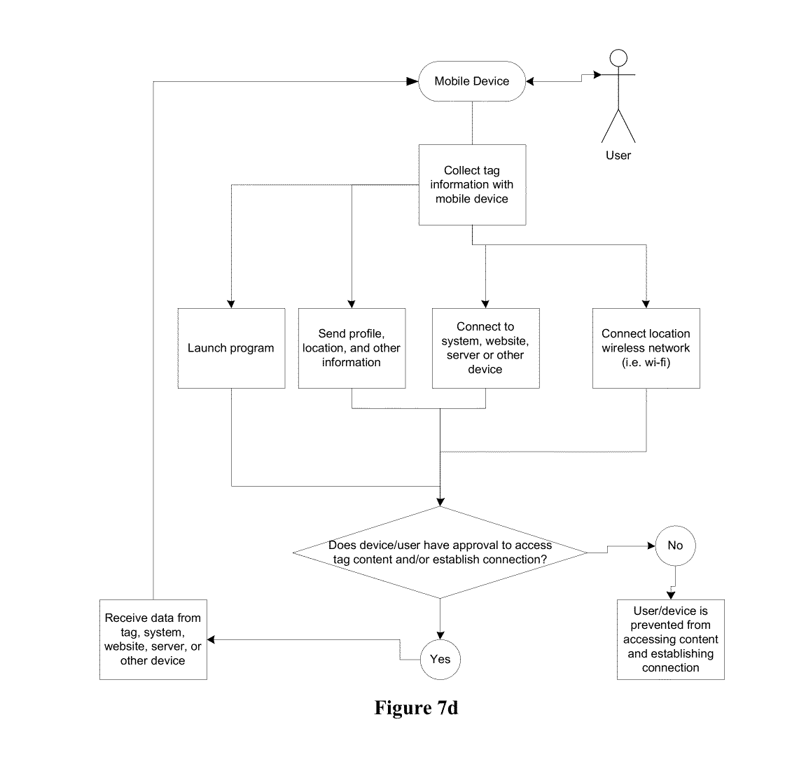

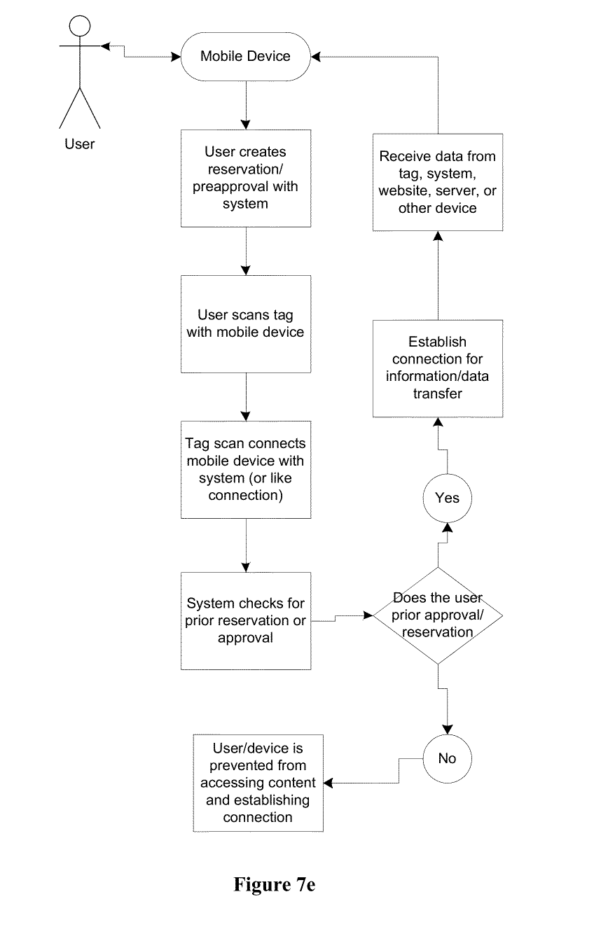

FIG. 7a is an illustration of a system for which approval requirements must be met before tag interactions allow a mobile device to connect with a system.

FIG. 7b is an illustration in which a second mobile device (or electronic device) user enables the authentication or approval of the tag scanning mobile device user. In this configuration, a first mobile device user scanning a RFID tag and upon scanning, a second user must approve the first user to be able to use the tag to facilitate additional interactions.

FIG. 7c is an illustration of the process in which the mobile device user may seek approval to access additional content, networks, or services.

FIG. 7d is an illustration in which the approval process occurs after the tag already facilitates at least one connection or data transfer.

FIG. 7e is an illustration of a process in which user approval is dependent on approval data available in a system or other like means. An example of a requirement for approval is where a mobile device attempting to access a business's network must be a device that is owned and issued by the business. A second example is a situation in which a mobile device user makes reservations for a specific table at a restaurant at a specific time. The reservation may be made in-person, by phone, or electronically. When the user sits at an incorrect table or at an incorrect time and scans the RFID tag on the table, the user is not allowed to facilitate further interactions. In addition, the user is sent a message informing the user that the table or time does not match the user's reservation.

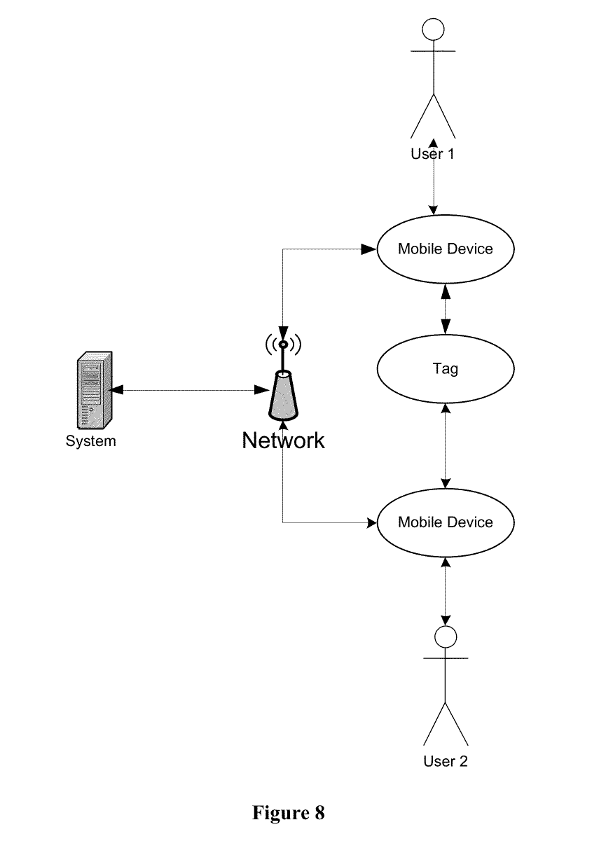

FIG. 8 is an illustration in which two mobile devices use the same tag to create connections. This connection can facilitate interaction between the two users or between the users and the system. The tag scanning does not need to occur at the same time.

An example of this configuration includes a situation where two users are bidding on one product (in-person or virtual), perhaps during a silent auction. A user interested in buying the product associated with the tag, scans the tag, and registers as a bidder. Multiple users do the same. Therefore, multiple users are able to submit bids for the product because the users initially scanned the product.

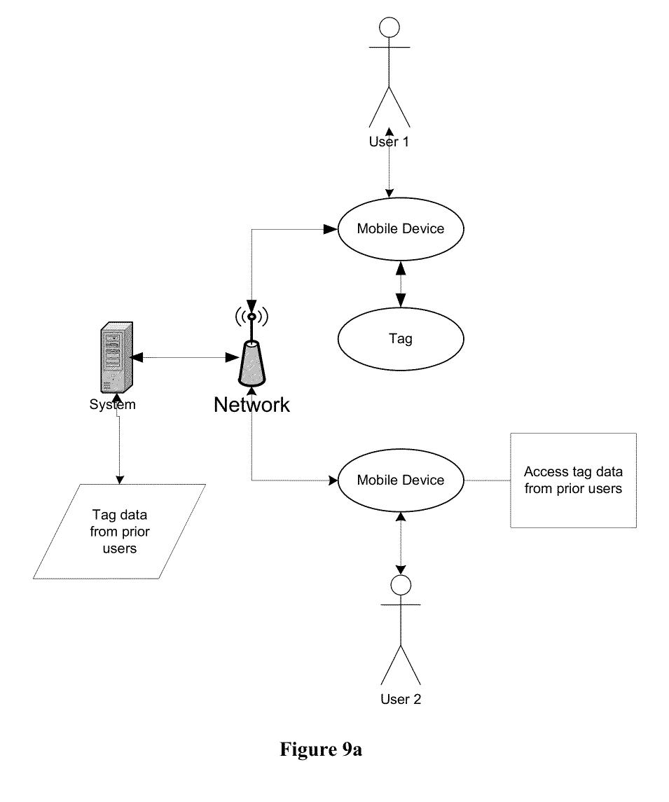

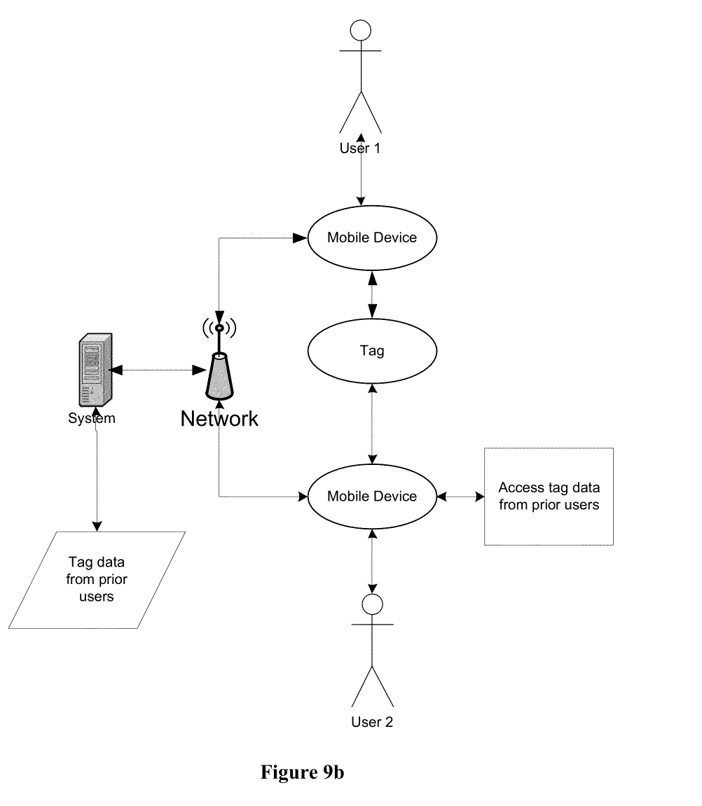

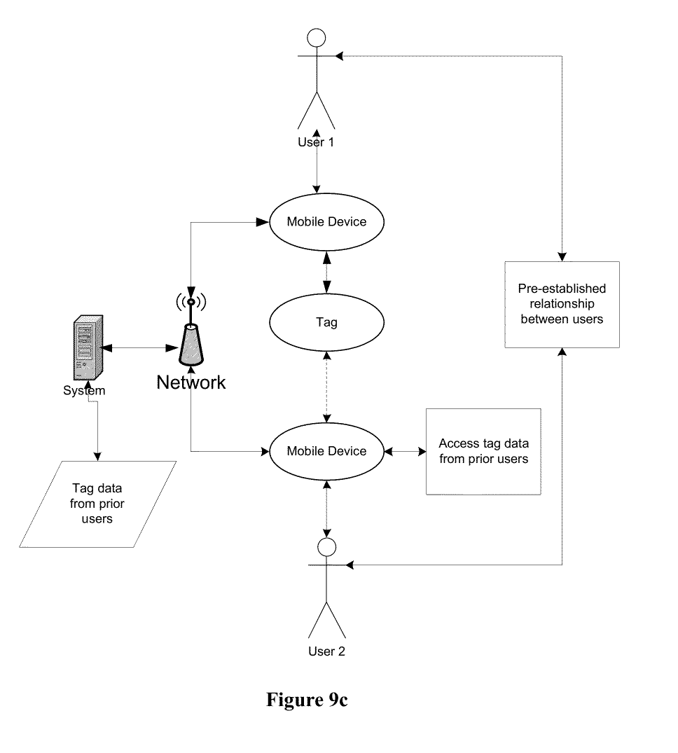

FIG. 9a is an illustration in which users can access prior history relating to a tag or collection of tags. The prior tag history is stored in a database or system accessible to a mobile device or electronic device user who has access to the database. Access of this information can be for internal or external system use. Therefore, a consumer may be able to access select tag related information and a tag provider may be able to access the same, less, or additional tag data.

A user being able to determine how many people have scanned tags at a restaurant, what was purchased, customer reviews, or other data collected through the tag interaction is an example of this embodiment.

FIG. 9b is an illustration in which a subsequent user (i.e. user 2) must scan the relevant tag to be able to access data related to prior tag interactions.

FIG. 9c is an illustration in which a subsequent user (i.e. user 2) must have a pre-established relationship with a prior user (i.e. user 1) to view data associated with user l's tag interaction. The user 2 may or may not be required to scan the tag.

An example of a pre-established relationship may include but is not limited to having user 1's email address or phone number or having a connection through another type of database or system (social media, work contact database, etc.).

The foregoing illustrations, embodiments, and examples are used in this disclosure to describe and convey the details of the present invention. These illustrations, embodiments, and examples do not represent an exhaustive list of embodiments and examples the present invention. One of ordinary skill in the art may recognize that the described tag and mobile device interactions may be facilitated by different means, the interactions may use different configurations, or may contain more or less sets, processes, or components than explicitly listed in this disclosure. When referring to a tag in this disclosure, one of ordinary skill in the art may appreciate that a tag may be an RFID, printed code, QR code, barcode or any other code a person skilled in the art will recognize as a tag. The illustrations, embodiments, and examples of this disclosure, may include at least one tag and at least one mobile device, at least one system and at least one network.

When referring to a mobile device in this disclosure, one of ordinary skill in the art may appreciate that a mobile device may embody one or more phones, tablets, laptops or other devices that one skilled in the art would recognize as mobile devices. When referring to a network in this disclosure, one of ordinary skill in the art may appreciate that a network may include Wireless Internets, Mobile broadband, 4G, 3G, Wi-Fi, a computer network or any other type of network a person skilled in the art would recognize as a network for the purposes of this invention. When referring to a system in this disclosure, one of ordinary skill in the art may appreciate that a system may include a server, database, website or any other system formation one skilled in the art recognizes as a system. Furthermore, the directional indicators (arrows and lines) used in the figures are not meant to limit the direction in which an interaction or transfer occurs. It is contemplated and foreseeable that interactions may occur in a direct not expressly illustrated in the figures of this disclosure.

Remote Payment and/or Approval

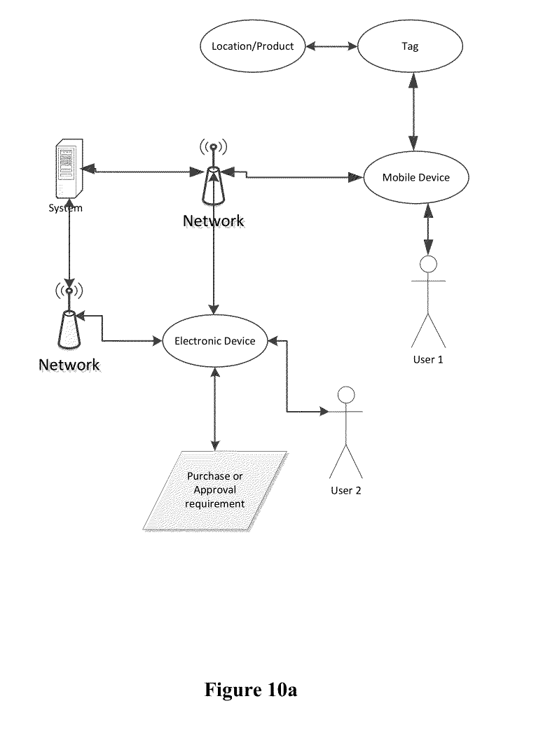

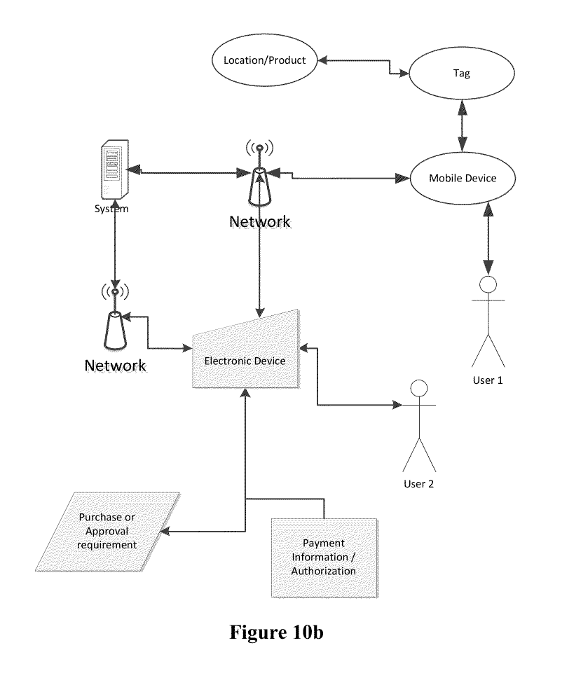

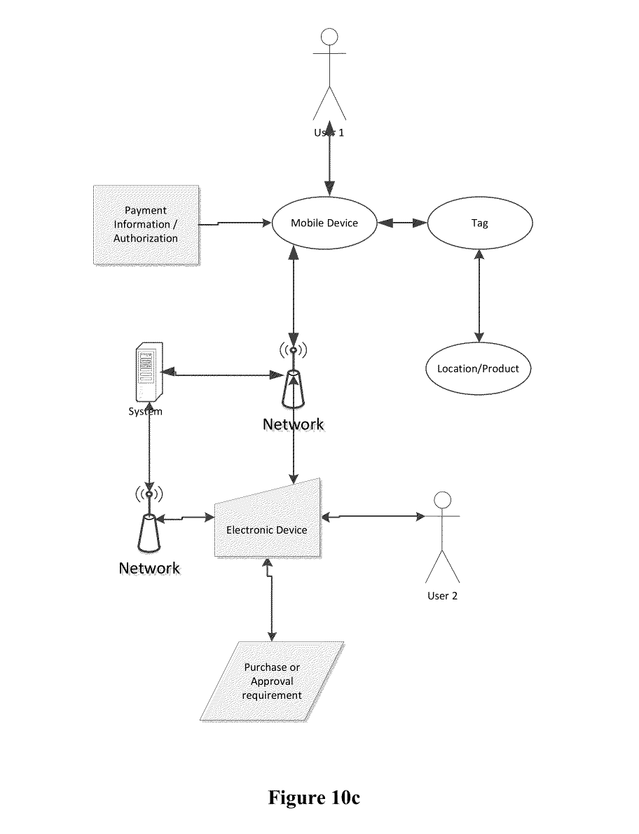

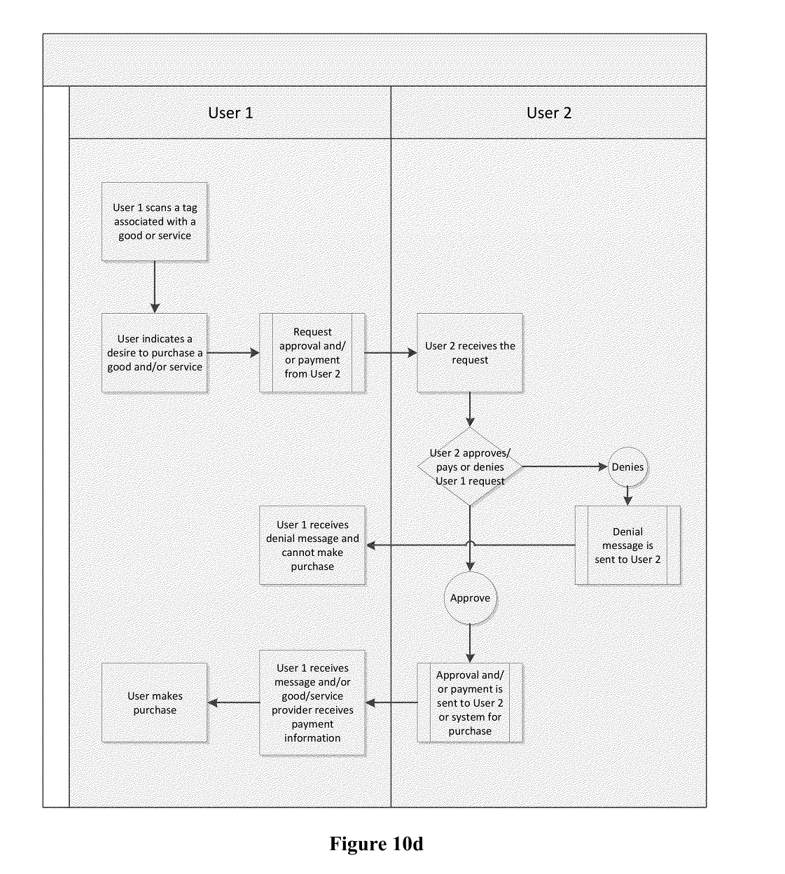

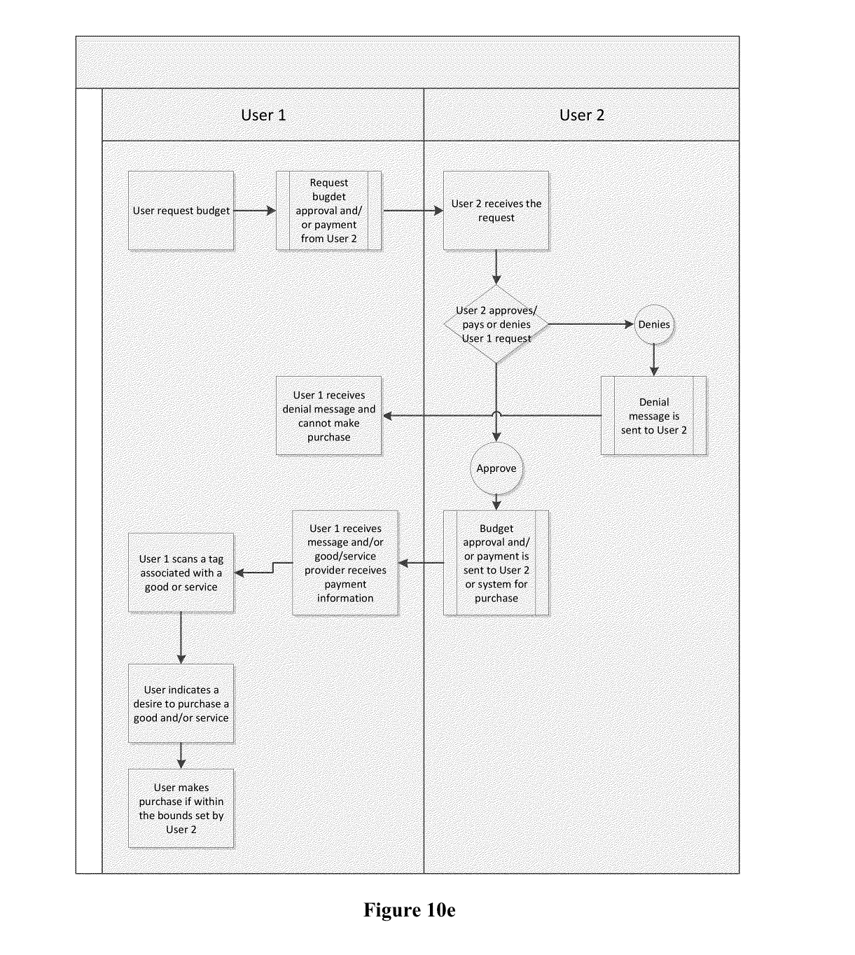

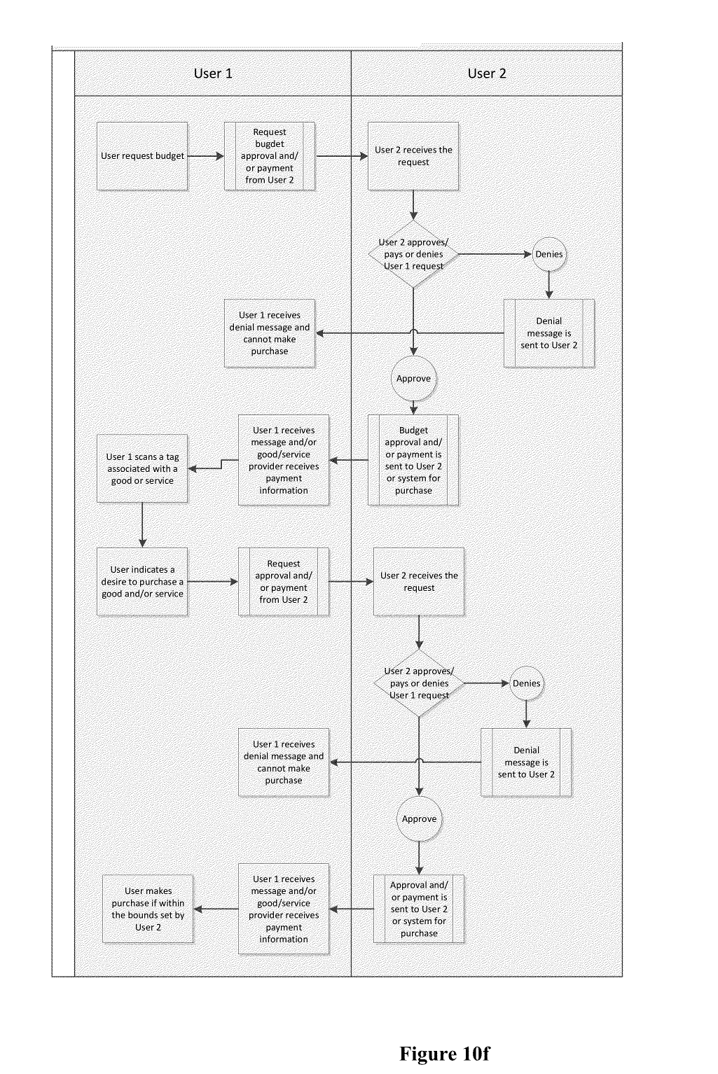

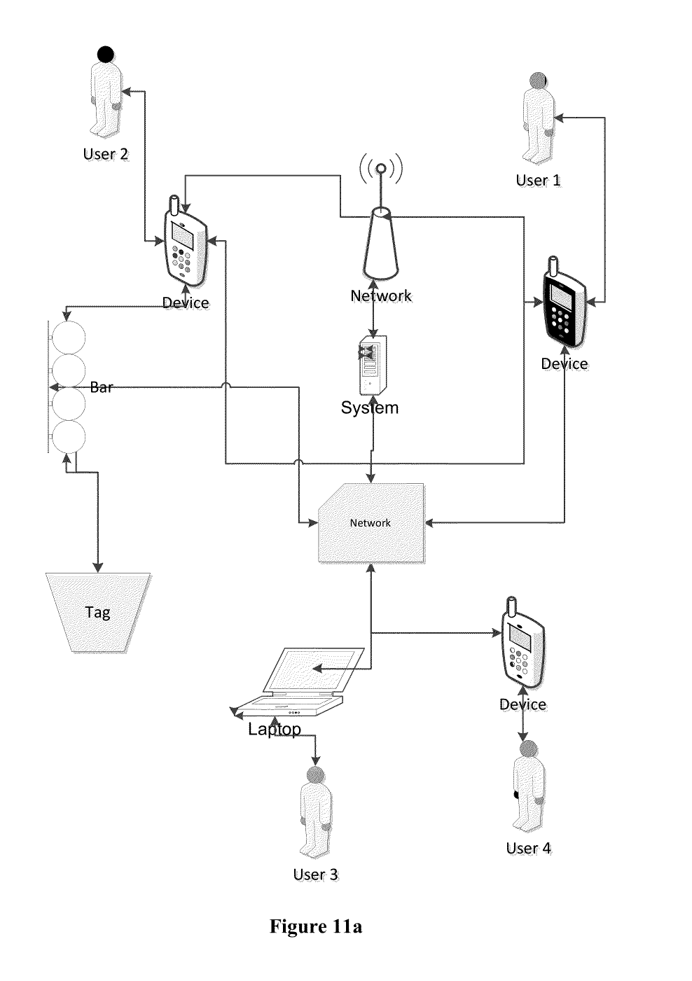

FIG. 10a is an illustration of an apparatus for facilitating remote purchase or purchase approval mobile transactions according to the present invention. In this illustration, a tag, sometimes referred to as a location marking device, is associated with a location or product. The location may be a table, chair, bench, counter, or other like specific location. The product may be any physical good. The tag is scannable by a mobile device that is used by a user. The mobile device is connected to at least one network that connects the mobile device to at least one system. At least one of the systems is connected to another electronic device controlled by a second user (User 2). This embodiment is used by a mobile device to initiate and/or complete a transaction involving the good/or service by using the mobile device as a means to identify the good or service and facilitate the transaction. In this embodiment, User 1 either seeks approval for purchase by User 2 or seeks payment by User 2.

FIG. 10b is an illustration of an apparatus for facilitating remote purchase authorization and purchase mobile transactions according to the present invention. In this illustration, User 2 controls the payment transaction. Therefore, when User 1 wants to purchase a good and/or service, User 1 must receive approval from User 2 and User 2 must send the payment for User 1's desired purchase. User 1 may request a budget in advance and/or User 2 may set a budget for User 1's purchases.

FIG. 10c is an illustration of an apparatus for facilitating remote purchase authorization and purchase mobile transactions according to the present invention. In this illustration, User 1 has the payment information or method but User 1 must get approval from User 2 to complete the transaction. Therefore, when User 1 wants to purchase a good and/or service, User 1 must receive approval from User 2 and only then can User 1 make the payment for the desired product/service. User 1 may request a budget in advance and/or User 2 may set a budget for User 1's purchases. As with the previous illustrations, User 2 may be at the same or different location than User 1. Furthermore, there may be three or more users involved. In such a case where there are three users, one user may request the purchase, a second user may approve the purchase, and a third user may provide the payment information/means. Although such a plurality of users is not shown it should be understandable from this disclosure how such an plurality of users would use such an apparatus.

FIG. 10d is an illustration of a method in which a mobile transaction can be remotely purchased and/or approved. As shown in the illustration, a User 1 with a mobile device scans a tag with associated with a good or service. Then the user indicates a desire to purchase the good or service. Using the mobile device, the user sends a request to a User 2. The request may be for a purchase approval, for payment, for a budget, for a recommendation, for similar functions, or combinations of these functions. User 2 can decide what action to take in response to User 1's request. If User 2 completely denies User 1's request, User 1 will receive no approval, payment, or other desired information. If User 2 approves the request on some level, whether it be authorization of the transaction, offering payment, setting a budget, or like approval, then the approval is sent to User 1. Then User 1 can make the purchase as enabled by User 2.

FIG. 10e is an illustration of a method in which a mobile transaction can be remotely purchased and/or approved. In this illustration, a User 1 uses a mobile device to request a budget for purchases and this request is sent to a User 2. User 2 can deny the request or approve the budget at some level. User 1 or User 2 may be the end payer of the purchase. After receiving approval by User 2, User 1 scans a tag associated with a good or service and makes the purchase, subject to restrictions set by User 2.

FIG. 10f is an illustration of a method in which a mobile transaction can be remotely purchased and/or approved. In this illustration, a User 1 requests a budget/payment authorization from User 2 and then User 2 must also approve the purchases that are made by User 1. Furthermore, although it is not illustrated in the figures, the budget request may occur after a User 1 scans a tag associated with a good or service. This would be the case when a User 1 scans a tag at a restaurant and requests a budget for purchases at that restaurant.

Another example of the remote payment is where a parent pays remotely for a child who wants to make a purchase. In such a scenario, the child goes to a store, for example a clothing store, and selects at least one item that the child would like to purchase. To pay the retailer for the good(s), the child makes a request to the child's parent to purchase the goods. The parent can authorize and/or pay the amount and also view the products selected by the child. Therefore, a parent only purchases approved goods and the child cannot bait and switch with the parent.

Reoccurring Transactions

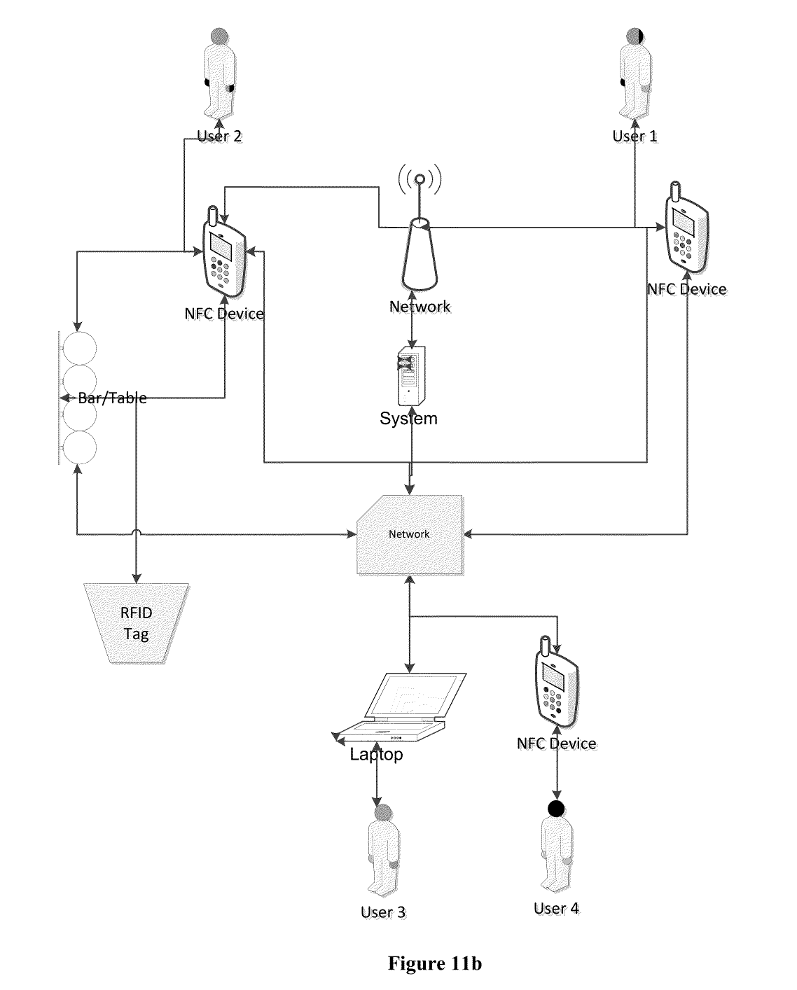

FIG. 11a is an illustration of an apparatus for facilitating remote mobile transactions at a bar/restaurant establishment according to the present invention. In this configuration, there are multiple users, some of whom may be at the establishment or not at/in the establishment, at least one network, at least one system, and at least one bar/table with a tag. User 2 creates a connection with the tag using with the mobile device. The tag is associated with a specific location in the establishment (i.e. table, bar, counter, etc.). The connection created by User 2 connects the user to the establishment or the mobile application system. With this connection, User 2 can open a payment account for purchasing a plurality of different items at different times while in the establishment. The opened payment account can be viewable by employees of the establishment to confirm that User 2 or someone associated with User 2 is the correct person(s) to be rendering goods or services to. Another user, User 1 may also be in the establishment or not in the establishment. User 2 may be required to approve User 1's purchases or may make the payment for User 2's transactions. In this illustration, User 3 is an establishment employee who uses or has access to a computer/laptop. User 4 is an establishment employee who is using a mobile electronic device.

An example of the illustration in FIG. 11a is where a User 2 opens/establishes a bar tab at a bar/restaurant by scanning a tag on the bar counter. Upon scanning the tag with the mobile device, User 2's device connects with the bar/restaurant. User 2's information, including payment information is sent to the bar/restaurant and User 2 has access to the restaurant information (i.e. menus, trend, etc.) and can make orders with the electronic device or in-person with one of the bar/restaurant employees.

User 1 can also make order requests that are to be paid by User 2. In this scenario, User 1 would need approval from User 2 before making charges to User 2's payment account. There are multiple ways in which User 1 may get approval to make orders or request orders to User 2. These ways include but are limited to sending a message to User 2 through the application or short message text, inputting a code known by User 2 into User 1's mobile device, or using NFC in the two devices to share the payment access/information. Once User 1 has approval to make orders, User 1 can make direct orders to the bar/restaurant or can make orders that still need to be approved by User 2, the payer.

This illustration, as well as others in this disclosure, can be used for apparatuses and processes to facilitate a variety of functions. One such function is allowing a person, need not be the holder of the payment account, to order a drink via mobile device or in person and when such an order happens, the holder of the payment information receives a notification about the order on his or her mobile device. Furthermore, although GPS is not illustrated in the Figures, the mobile devices may be GPS enabled. When a payment holder has an open tab and leaves the bar, the GPS on the mobile device identifies that the user is leaving the bar/restaurant and prompts the user to close his or her tab. Another function is a user with an open tab (sender) can send a full or limited menu to another mobile device user (a recipient). Then the recipient can choose to order one of the menu options and the order will be charged to the sender. An example of such a transaction includes when and where a person (buyer) is in a bar and would like to purchase another person a drink. Using a mobile device, the buyer sends a recipient a message stating that the recipient can purchase a drink on the buyer's tab. The message may be sent through email, an application, short text message, or other electronic messaging means. The buyer may limit the menu options or the price. When the recipient makes an order, it is billed to the buyer.

The details of this disclosure can also be used to facilitate additional functionality. Additional functions include enabling users who have scanned a tag to request songs to be played, television channels to be tuned in to, and/or environment changes, such as lighting and climate. Furthermore, a user can choose to tip a server per service/transaction or to consolidate all tips until all transactions/services are completed. Therefore a user can tip per drink or tip at the end of the evening after multiple drinks have been purchased. As mentioned, users can pre-order drinks to pick up or have delivered to their location.

FIG. 11b is an illustration of an apparatus for facilitating remote mobile transactions at a bar/restaurant establishment according to the present invention. This illustration shows a preferred embodiment in which the mobile devices are NFC enabled devices.

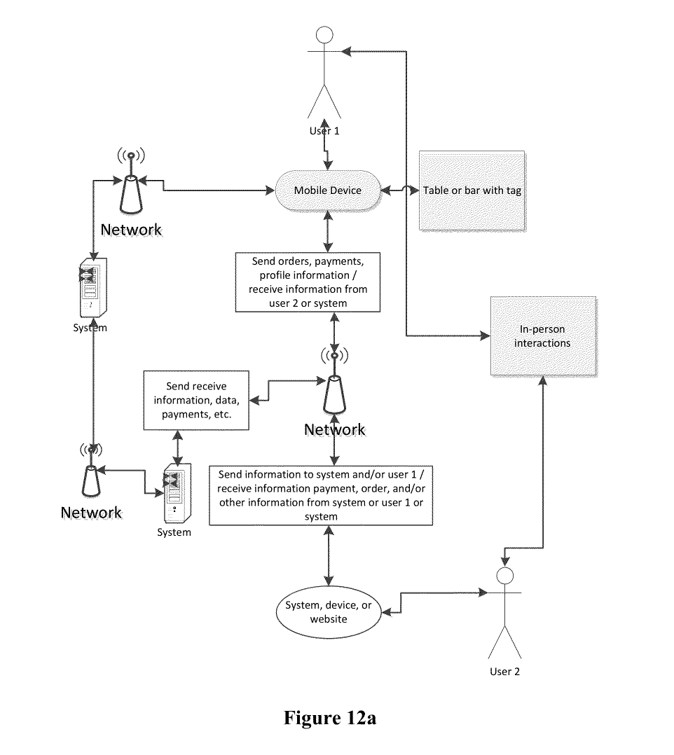

FIG. 12a is an illustration of an apparatus for facilitating reoccurring mobile transactions according to the present invention. In this illustration, a User 1 with a mobile device scans a table or bar with a tag. The mobile device may already be connected to a wireless carrier network or other wireless network. Scanning the tag allows the mobile device to connect to a network to send orders, payments, and profile information and to receive information. User 1 can send information to and receive information from a User 2 through one or more networks. In the context of this disclosure, User 2 is typically an employee of a goods and/services provider. For rendering payment, a third party payment system may be accessed to retrieve User 1's funds/credit to pay a goods and/or services provider.

This illustration shows that in-person interactions can be used in addition to electronic communication to facilitate orders and other interactions. For example, a person sitting at a table could place an order in-person to a server and/or order through the mobile device that has scanned the tag associated with the seating location.

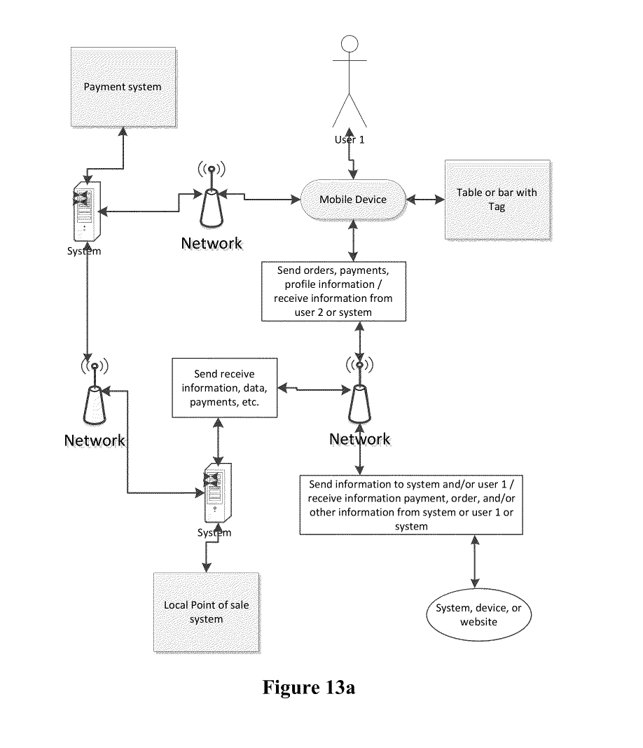

FIG. 13a is an illustration of an apparatus for facilitating remote mobile transactions according to the present invention. An example in which such a configuration could be used is for order and delivery to a consumer who is not located at a good/service provider's establishment. For example, a table in a school lounge or a park is tagged and that tag is associated with that specific location. Upon a user scanning the table with a mobile device, the mobile device is connected a system that contains information for ordering pizza from a variety of establishments. The user can select a provider and make an order. The user's payment information is sent to the provider as well as the specific location of the user who made the order. Therefore, the provider knows exactly where to deliver the ordered items. Tagging a specific location has an advantage over GPS because of the limitations of GPS inside structures.

Payment Splitting

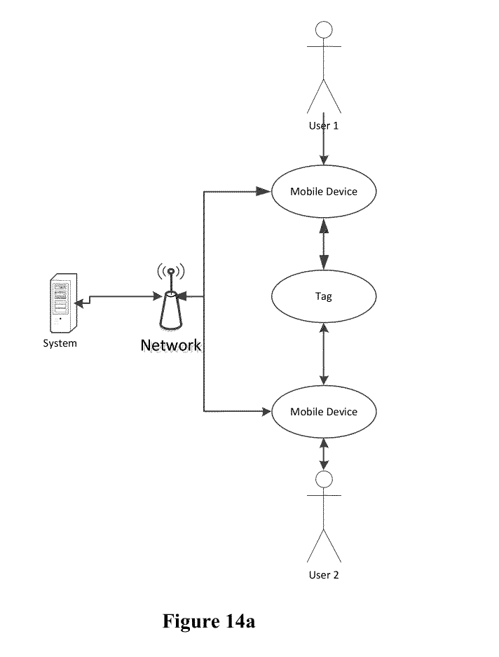

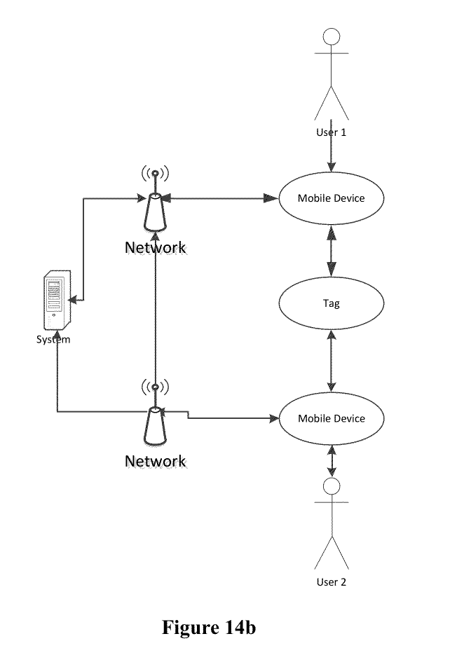

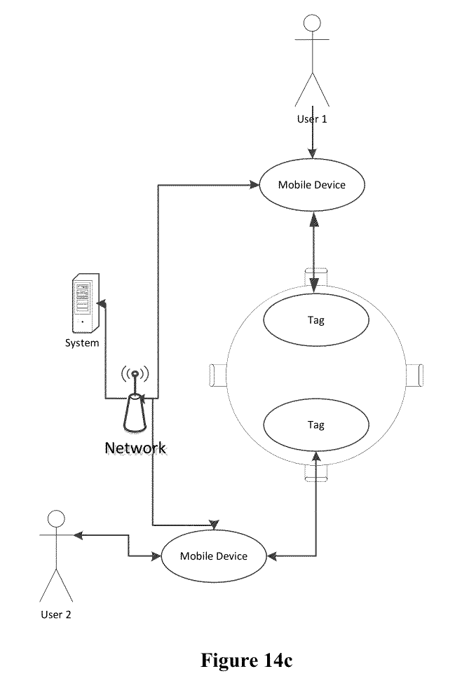

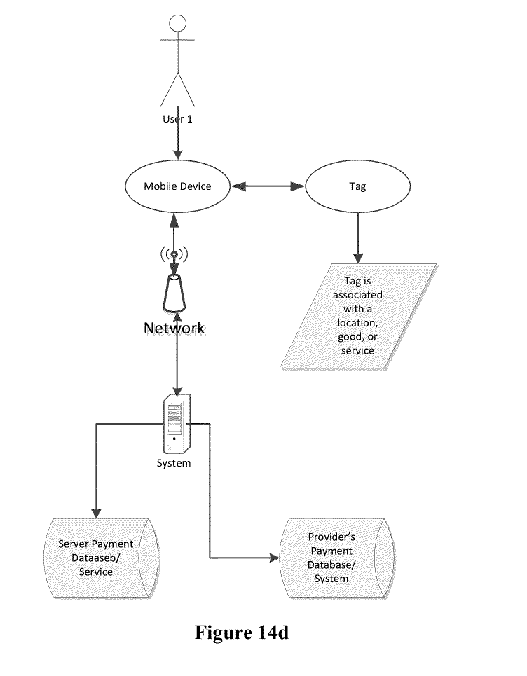

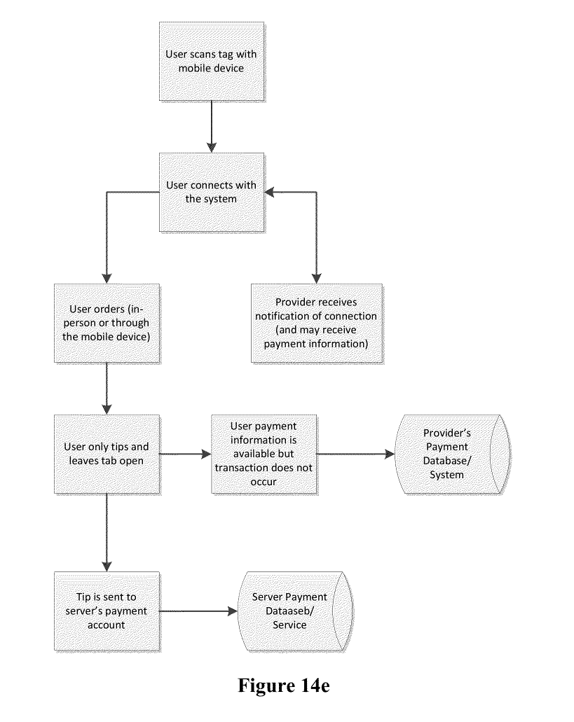

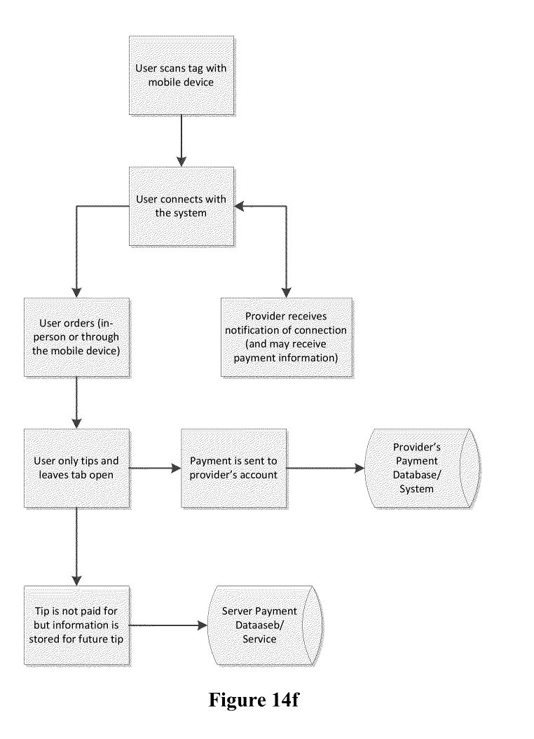

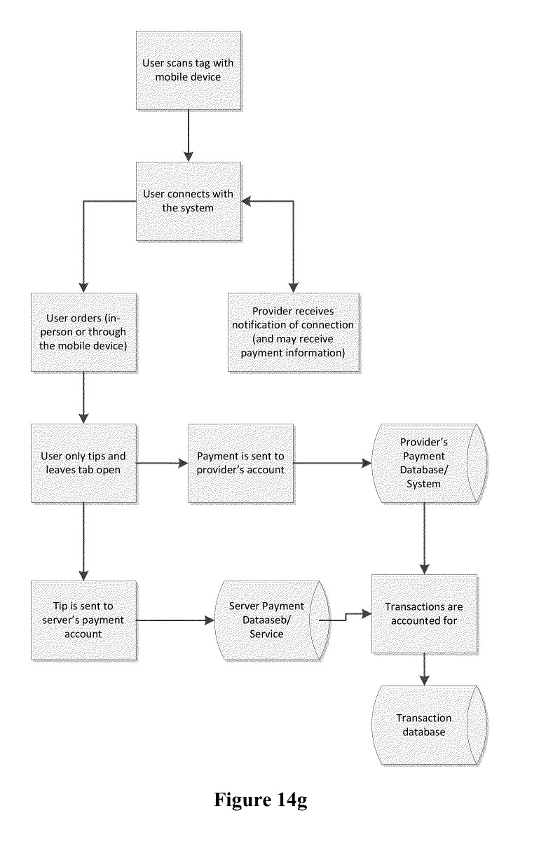

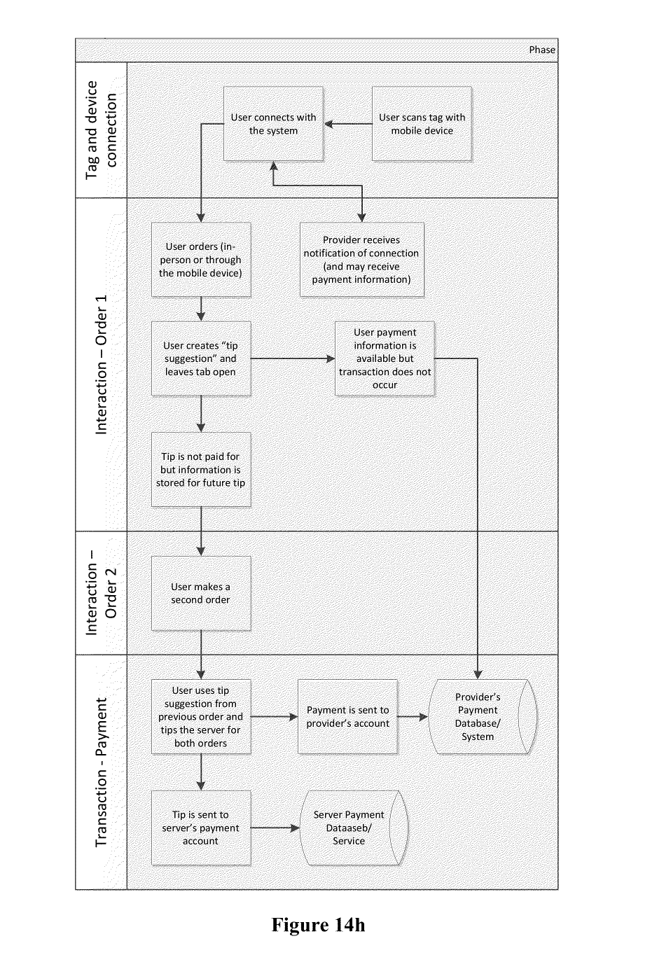

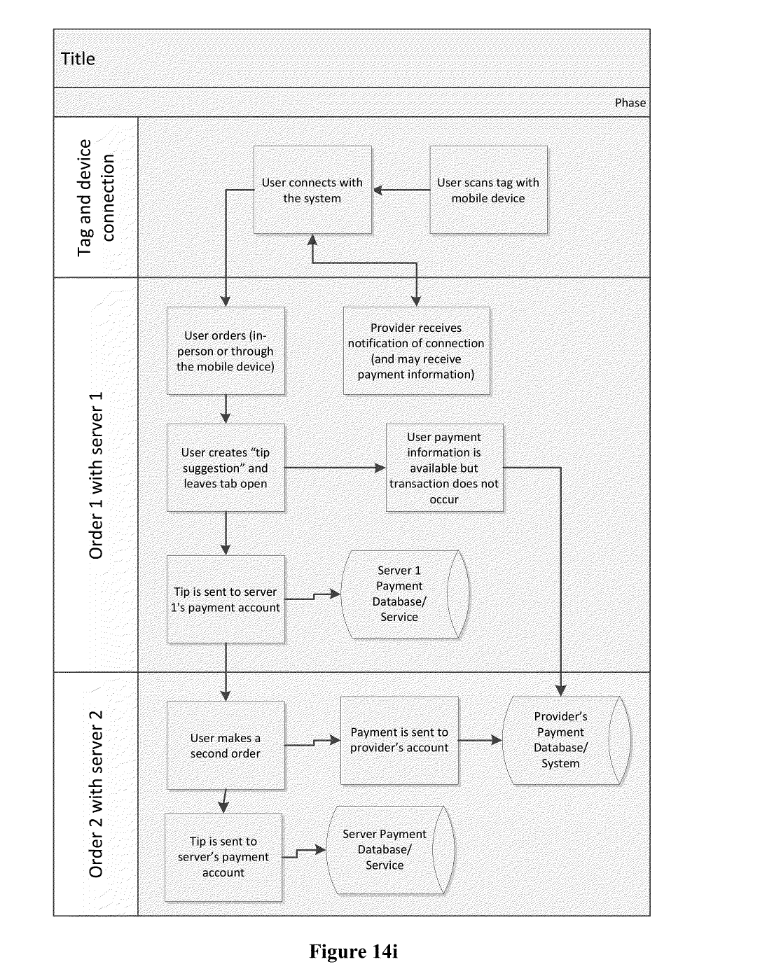

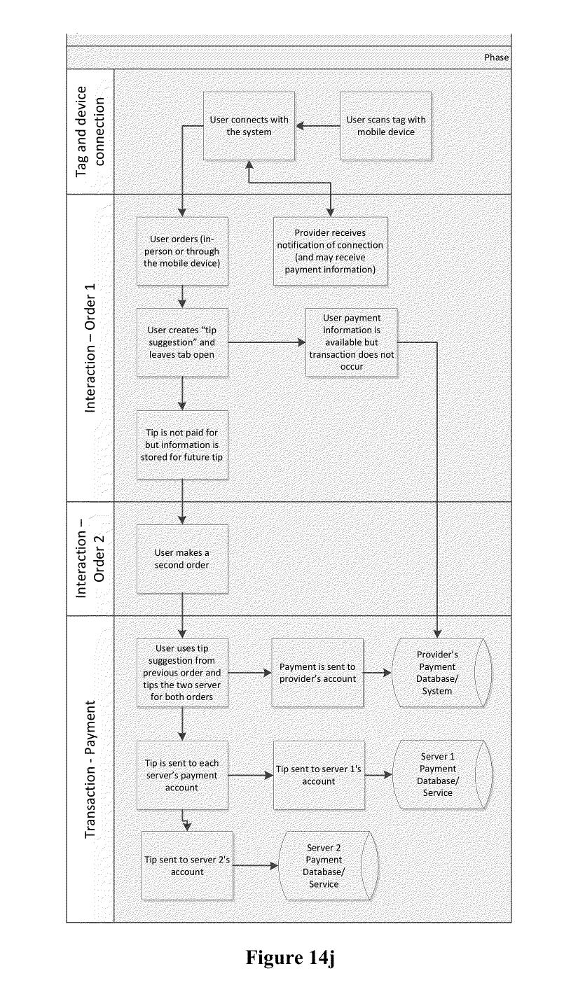

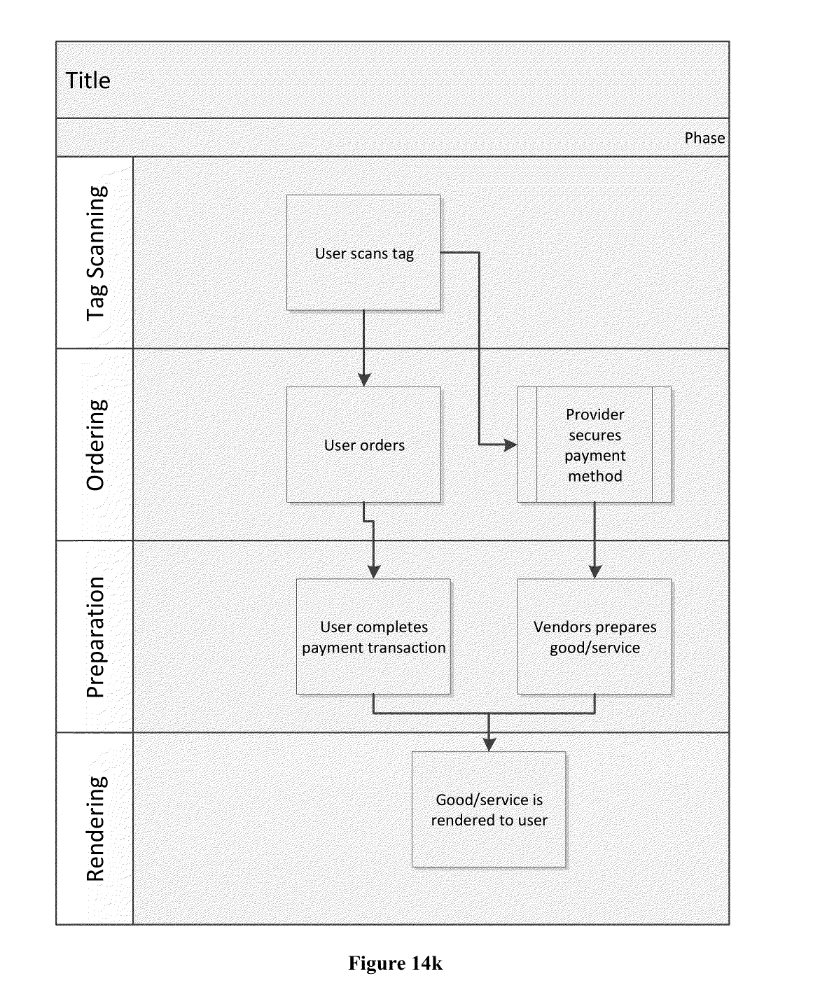

FIG. 14a is an illustration of an apparatus for facilitating payment splitting in mobile transactions, according to the present invention. In this configuration, at least two mobile device users scan the same tag or associated tags. These users are connected to at least one network and the network connects the users to at least one system. Using this configuration, the plurality of users can split one bill for a purchase of goods and/or services.

FIG. 14b is an illustration of an apparatus for facilitating payment splitting in mobile transactions, according to the present invention. In this illustration, a plurality of networks is shown. Although not shown, more mobile devices can be used and a plurality of systems can be used.

FIG. 14c is an illustration of an apparatus for facilitating payment splitting in mobile transactions, according to the present invention. In this illustration, more than one tag is associated with the same good and/or service. Although only one network and system is shown, this configuration can use a plurality of the networks and a plurality of systems. Furthermore, more than two tags can be associated with a good/service and more than two users can split the payment.

An example of the above is where two people are eating at a restaurant. The two people make orders in-person. The restaurant compiles the bill as one aggregate amount. The customer can scan the tag on the table to access the bill information. The two users can then select which items they would like to pay for or select an amount they would like to pay. Obviously, the total sum of the bill must be paid by the two. Furthermore, the two customers can tip separately.

FIG. 14d is an illustration of an apparatus for facilitating splitting good/service payment and tip payments. This method may include one or more mobile device users (tippers), one or more tip recipients, one or more networks, one or more systems, and more than two payment databases.

FIG. 14e is an illustration of a method for facilitating splitting good/service payment and tip payments. In this illustration, a mobile device user scans a tag and connects to a system; the provider receives notification of the connection and may receive information to secure payment. The user can make orders for goods/services, either in-person or using the mobile device. After ordering the user sends a tip to the server's account but the user's “tab” for the provider's goods/service remains open so the user can continue to make purchases.

Although the provider payment and tip accounts are shown separately in these illustrations, this method and the other methods in this disclosure can be used where there is only one payment account. Furthermore, there may be a plurality of provider accounts and a plurality of tip/server accounts.

FIG. 14f is an illustration of a method for facilitating splitting good/service payment and tip payments. In this illustration, the user pays for the order but does not tip. The user instead makes an electronic note of the service and a suggested tip. Therefore, the user can tip the server at a later time.

FIG. 14g is an illustration of a method for facilitating splitting good/service payment and tip payments. In this illustration, the payments that are sent to different accounts are accounted for by one or more systems and/or one or more databases. This allows for the provider to keep an accounting record or the tips being given to the servers. Although the word “server” in this illustration is sometime used as a name for electronic system, the word server is sometimes used as a name for a waiter or waitress. The context in which the word is used should make it apparent which meaning is to be given to the word.

FIG. 14h is an illustration of a method for facilitating splitting good/service payment and tip payments. In this illustration, the user makes multiple orders and complies the payment and tip information until all transactions are completed.

An example of electronic tipping is where a mobile device user is at a bar. Before or after ordering a drink, the user scans a tag and connects to the bar's system or a payment system. To pay for the drink, the user can pay for it after ordering or pay for it at the end of the transaction(s) (after a night at a bar). If a person does not want to pay for the drink and leave the tab open, the user can still send a tip to the bartender/server. This tip can be sent directly to the bartender/server payment account or the establishment's account. If the tip is sent to the bartender/server's account, an accounting of the tip is provided to the establishment. Sending the payment directly to the bartender/server's account has a benefit of eliminated the need for the establishment making an additional payment transaction to the server. In addition, the splitting of the bill and tip allows the mobile device user to make two separate transactions and track the bill for service and the payment for the tip. If a person does not want to pay for the drink and not want to tip at that time, the person can put in a “tip amount suggestion” and “bartender/server” on the mobile user's device and store the information for when the user submits the payment or tips.

FIG. 14i is an illustration of a method for facilitating splitting good/service payment and tip payments. In this illustration, the user makes multiple orders with multiple establishment employees (servers). Although not explicitly illustrated, this method can be used with multiple mobile device user.

FIG. 14j is an illustration of a method for facilitating splitting good/service payment and tip payments. In this illustration, a mobile device user scans a tag and the user is connected to a system. The provider of goods/services receives information from the user's mobile device and the user is able to order (in-person or through the mobile device). The user decides not to pay for the order and not to tip at that time. Instead, the user may or may not make an electronic tip suggestion to give to the provider's employee for the goods/services rendered. In addition, the provider is not paid at that time but the provider has already secured that a payment will be made for the order. Securing the payment could be done by securing the user's payment account information (like holding a credit card for a reservation) or the provider may rely on a third party that has access to the user's account or provides credit to the user.

The user then makes a second order with a second provider employee. After this order, the user completes payment to the providers payment account and sends tips to the each of the servers, including to their separate payment accounts. The user can input the tip and may use the information for a previous tip suggestion that was input into the mobile device. Also, tip suggestions, can come from other mobile device user that the payer is associated/friends with.

One of the benefits of the system above is that a user may tip multiple servers individually at one establishment. If at a bar and ordering drinks from different areas, (different bar counters or tables) the user can scan the tag when the user is purchasing the drink to keep track of which employees provided the service. Then the user can distribute the tip accordingly. Another benefit is that a user is does not always provide a tip when purchasing each drink.

The tip splitting also applies to restaurant, cafes, and other service that include tipping. The tipping and bill splitting is not limited to only transactions created after the tag connection. The splitting of payments can apply where the interaction/service has already been rendered.

FIG. 14k is an illustration of a method for facilitating ordering and paying at separate times. In this illustration, the user scans a tag. The tag scan allows the user to order and the provider secures payment. While the vendor is preparing the order, the user can complete the transaction for the price required. After the user completes the transaction, the provider renders the good/service to the user.

An example where the details of this disclosure can be used is for mobile services (i.e. food trucks, gardening, etc.). In this example, a user orders food from a mobile vendor. Then a user scans a tag on mobile establishment (or provided by the vendor). Through the mobile device, the user can send payment for the good or service. The vendor can receive payment to the vendors payment account and confirm payment with an electronic device. Therefore, the vendor could have a computer screen that would notify the vendor that payment was received. After receiving the payment, the vendor gives the food to the customer. This allows the vendor to make the food and the user pay for the goods at the same time. Furthermore, where the scanning is done before or during the ordering process, the user can step away and let the vender make the food while the user completes the payment. By having the scan occur before or during the transaction, the vendors/service providers can identify users by the time they scan, having a picture of the user populate upon scanning, or other suitable identification method.

A user could also pre-order food. A benefit of this system, as well as other systems in this disclosure or where foreseeable, is that a person can order food electronically in person before payment and then the user can pay with the mobile device while the services are being rendered, and receive the goods/services after payment is received. An example of this is where a mobile device user purchases food from a fast-food establishment (or any food vender—i.e. state fairs). Therefore, a user orders the food at a terminal, with or without an employee. The user can scan a tag before ordering, during ordering, or be given a tag to scan after ordering. If the tag is scanned after ordering, the order identification will need to be contained on the tag or the user will need to have information to identify the order. After ordering, the user can step away from the purchasing terminal and use the connection established by scanning the tag to pay for the order. The restaurant receives the payment while making the food and then the user can collect the food. A benefit of having the user scan the tag and establishing the connection before or during order is that the restaurant can secure a payment method, similar to the manner a credit card is used to secure payment for a future transaction. Another benefit is that the user can complete the transaction while not engaging with an employee. Therefore employees are free to serve other customers.

Another benefit of the tag and mobile device, as described in this disclosure, is that payment for a service can be made at an alternative time than an accompanying tip. Therefore, if a mobile device user purchases a cake through a tag facilitated connection (scan a tag, order a cake, pay for cake with mobile device, pick up cake, and eat/leave), the mobile device user can make the payment charged by the provider and then, based on the user satisfaction after the purchase, can tip using the connection information from scanning the tag. Therefore, in the cake purchasing example, the user can submit a tip after the user has eaten the cake. The provider, a system, or the mobile application may be used to prompt the user to tip. Furthermore, a system or provider may ask questions to the mobile user or the mobile device/purchaser can add comments to the tip. It should also be noted that the ability to add comments to payments can be used in many of the embodiments in this disclosure as well as other payment methods capable of enabling comments. Therefore, a user could tell the cake bakery that the cake was great. If the user wishes, the comments could be made anonymous using software, a third party, or other method that service this purpose of anonymous comments.

This can be done after the tag connection has been disconnected because it uses the information from that connection. In addition, this tipping method, as well as other details of this disclosure, can be used with other payment methods, such as paying with an NFC at an NFC payment terminal. A service provider may also hand out tags to the user that the user scans to make the mobile connection. In addition, panhandlers could use this for collecting money. A user scans an NFC tag that the panhandler possesses and the user can send payment to the panhandlers account. A benefit of this would be that this transaction would be accounted for and taxed.

Shopping Tracker

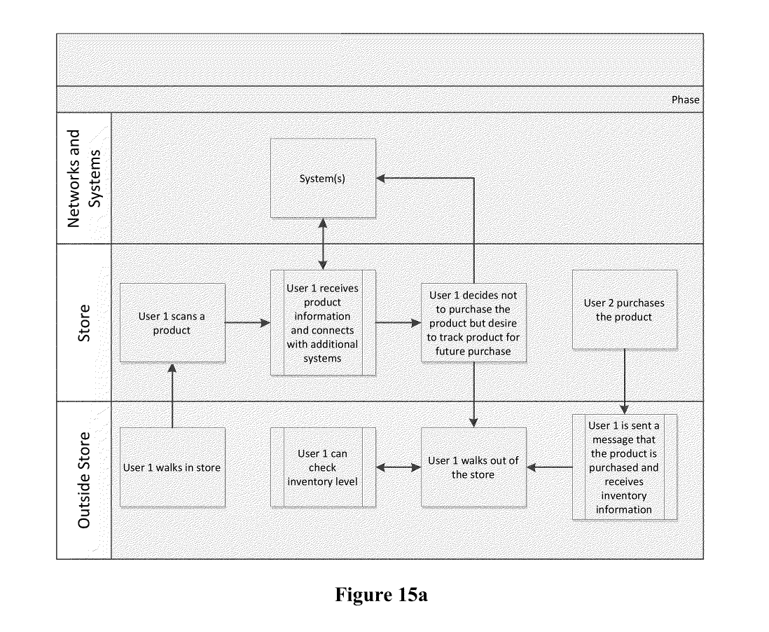

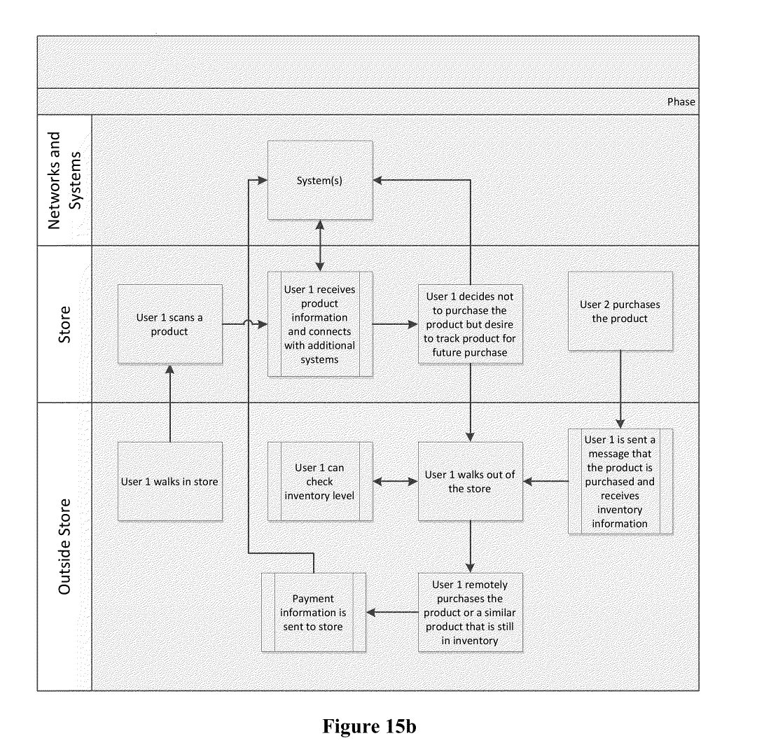

FIG. 15a is an illustration of a method for facilitating tracking products, according to the present invention. In this process, a User 1 walks into a store and scans a tagged product with a mobile device. The user receives product information and can decide whether to purchase the product. When User 1 decides not to purchase the product but would like to track the product for a future purchase, User 1 can make such a request to receive inventory and price information related to that specific product, identical products, and/or similar products. User 1 then leaves the store. After leaving the store (or even while still in the store), User 1 can check the inventory levels of the desired products to identify whether the product(s) is still available at the store. When a subsequent user, i.e. User 2, scans and/or purchases one of the products scanned or being tracked by User 1, User 1 receives notification of User 2's activities. Therefore, if a certain product is getting a large amount of scanning or purchasing activity, User 1 will know that the product may not be available in the near future and User 1 will need to make a purchase if User 1 desires to have the product.

An alternative to FIG. 15a is that a customer can scan the product and request that the item be put on “hold” for a period of time. The consumer scans the product and elects the “hold” option. The store subsequently accepts or rejects the request. If the request if accepted, then at least one item of the scanned product will be frozen or prevented from being purchased from a subsequent consumer for the set period of time. If the request is rejected, then the item remains available to any subsequent buyer. Whether the “hold” request is rejected or accepted, the consumer has the option of receiving updates on inventory levels.

Lastly, if the consumer decides to purchase the item but does not want to go back to the store within the “hold” period, the consumer can chose to purchase the item and have it shipped to a destination of choice. This transaction is done as if the consumer purchased the item in store, but rather than having the customer take the item out the store with them after the purchase, the store ships the item to the consumer as an off-site purchase. The item may also be shipped from a warehouse.

FIG. 15b is an illustration of a method for facilitating the tracking of products and marking a remote purchase, according to the present invention. In this illustration, User 1 can make a remote purchase while not being in the store. The purchase allows User 1 to reserve the product and make an in-store pickup. In addition, User 1 may choose to have the product shipped, if shipping is available.

In another aspect of this disclosure, the details herein can be used to track products and track prices. When a mobile device user scans a tag associated with a product/service/location, the user can view the product information, including the price, and save that data to the user's database. Then when the user scans that tag at a later time, the user can compare the current price to the former price. Furthermore, the user can see how many other users have purchased the product/service and/or scanned the tag since the user's previous scan.

A mobile device user can also scan a tag to receive previous purchases, comments, or similar information from previous users. Therefore, if a first user sits at a table in a restaurant, orders food, takes pictures or records video, and leaves comments, a second user (may or not know first user) can see this information if the first user makes it available. This process can be used for more than two users.

This information can be limited by the owner or operator of the establishment(s) such that it can be accessed by as many or as few users as the owner/operator desires. For example, this information may only be available to individuals that have some type of relationship (friend, family, associate) such that the user's mobile device will be able to recognize and access the previous user's comments, pictures, or other information regarding the establishment. A further restriction on comments and posts left by previous users is that there could a time of day restriction so that you can only see when a person was there and left their review, or the item from the menu regarding the review. This information could then be used by the current user to either order the same item (i.e. food, drinks, special) that the previous user ordered. It could be further restricted to the time of day that a second user scan the tag, what first and second user purchase, or by requiring the second user have to pass some sort of test. Therefore, a second user who is a friend of the first user may have to scan the day 24 hours later and order the same thing that the first user ordered to see the first user's stored content

Content Access

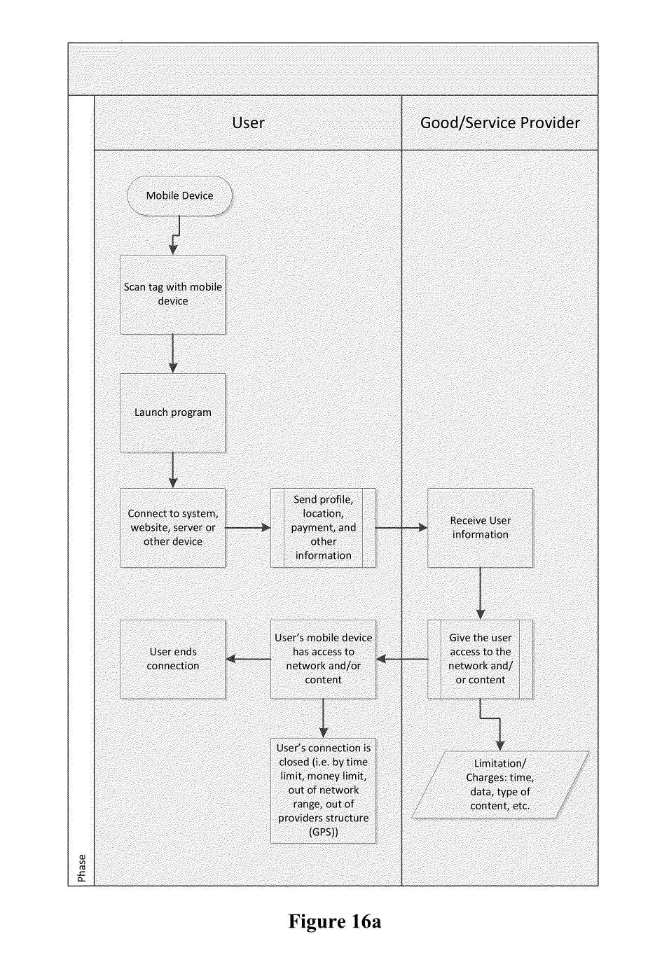

FIG. 16a is an illustration of a method for facilitating reservations and services, according to the present invention. In this method, a user with a mobile device scans a tag associated with a good or service, preferably on a table. The mobile device then launches a mobile application (if the application is not already running). The mobile device connects to a system, website, server, or other like database or service. The user is then able to send and receive information with the provider's system or systems. One of the items that the user sends is payment information to access “premium” content. Such content may include subscription-based content including newspapers, books, and/or magazines. The user's access to the content may be subject to limitations including but not limited to level of payment, type of content, and time limits. The user no longer can access the content if the user is no longer connected to the network and/or system of the provider, the user leaves the location (identified by GPS), or other limiting reasons.

An example of this method being used is where a café allows users to purchase a good/service in order to access premium content while at the restaurant. In order to initiate this access, the user must scan a tag at a table to indicate the physical presence in the establishment or at the location. The user can be billed through the café or through a separate application or system.

Reservations

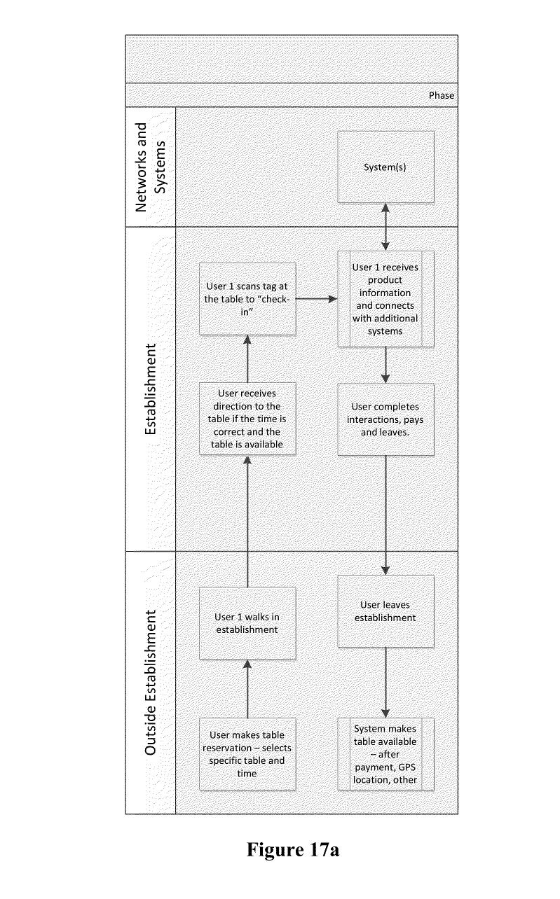

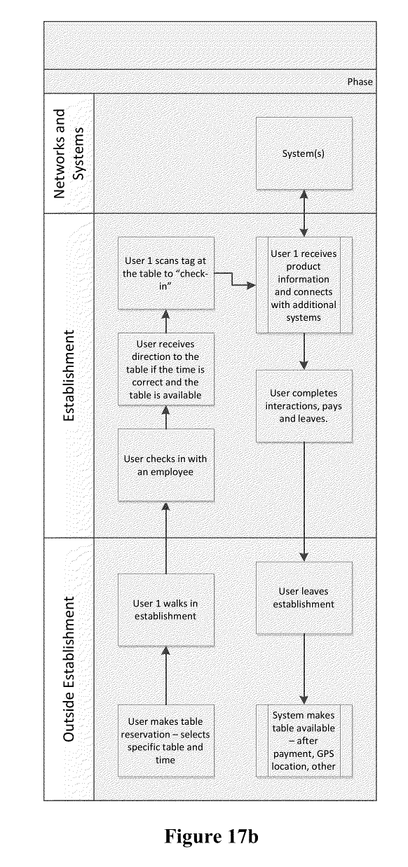

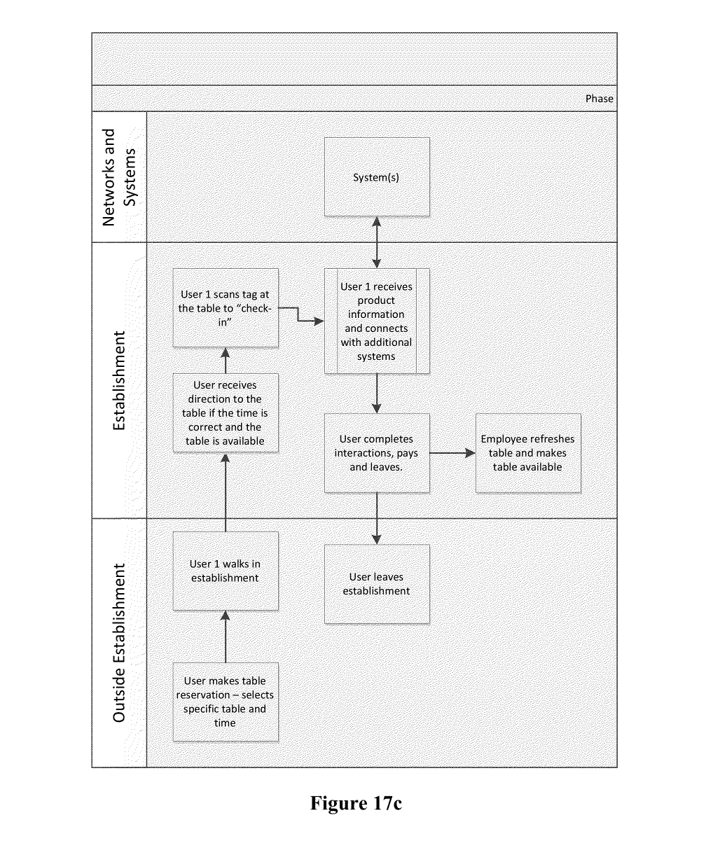

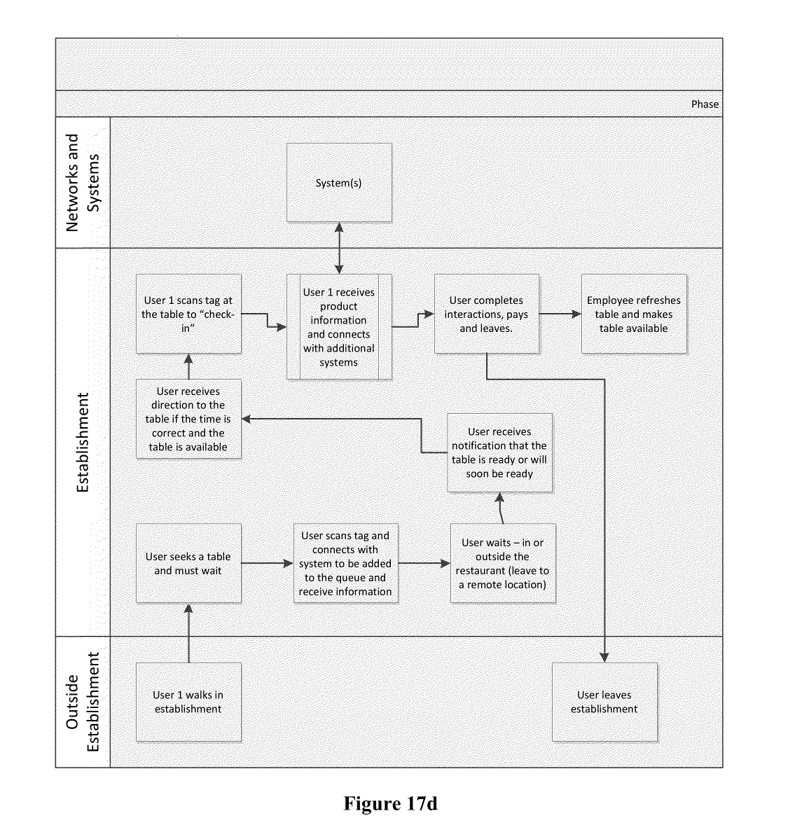

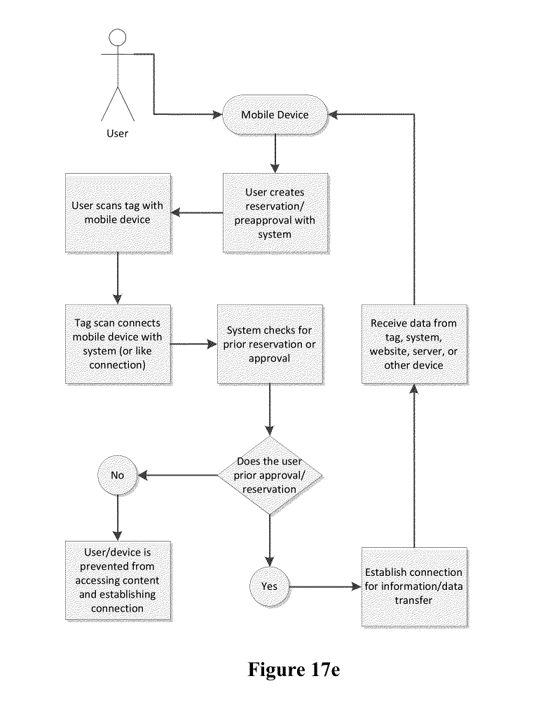

FIG. 17a is an illustration of a method for facilitating reservations and services, according to the present invention. As illustrated, a user makes a reservation for a restaurant, which may include a specific table at a specific time. Then the user walks into the establishment and receives directions to the table. The user's presence in the establishment may be done by a variety of means including but not limited to GPS location identification, scanning a tag upon arriving at the establishment, user initiating the location of the user, or other means of achieving this function. The user then scans the tag on the table and indicates the user's presence at the table. The user, connected through a tag-facilitated connection or existing connection, sends the user's information to the establishment and receives information from the establishment's system or systems. The user can make purchases and other interactions and transactions listed herein and those foreseeable. When the user leaves the table, the table is then available for another user to scan the tag and order the goods and services of the establishment.

FIG. 17b is an illustration of a method for facilitating reservations, according to the present invention. In this illustration, the user checks in with an employee before being seating at the table.

FIG. 17c is an illustration of a method for facilitating reservations, according to the present invention. In this illustration, an employee refreshes the table and scans the tag with a mobile device to make it available for the next user. The employee's scan of the tag indicates to a system that the table is now available.

FIG. 17d is an illustration of a method for facilitating reservations, according to the present invention. In this illustration, the user must wait (or first check-in) before getting a table. In this method, the user scans a tag with a mobile device and connects to a system. Then the user is able to add the user (as well as other people in the user's party) to the queue for a table. The user is then set up to receive information from the system about how long the wait is, when the table is ready, and like information. In addition, a shortened menu will be available for the user to place drink orders with the bartender while the user waits for the table to become available. Then when the table is ready, the user checks-in to the table by scanning the tag on the table. Therefore, an apparatus used for this method may require more than one tag for functionality. The user need not stay near the restaurant. Furthermore, the user can remove the user (and user's party) from the queue. In addition, the user can order food and drink so when the user does get the table, food and drink are already there or in progress.

FIG. 17e is an illustration of a method for facilitating reservations, according to the present invention. In this process, a user with a mobile device creates a reservation for a good and/or service. Then the user scans a tag associated with a good and/or service that the user made or tried to make a reservation for. After scanning the tag, the mobile device is connected to a system and the system checks for a prior reservation (or other type of approval) for the user. Depending on the approval, the user is either allowed to access the system and information or is prevented from accessing the content/network.

Although not explicitly illustrated, the details of this disclosure are meant to facilitate additional transactions and interactions that are enabled by the scanning of a tag associated with a specific product, location, and/or service. Examples of additional functionality include accessing a camera to view the kitchen, including when the user's good is actually being prepared. The user is able to access messages, pictures, and videos created by previous users and the user is able to create his or her own content for subsequent users. The users may leave messages on the payment transactions. The user can also access inventory levels (i.e. wine) and food purchase histories and review.

Remote Payment and Pickup

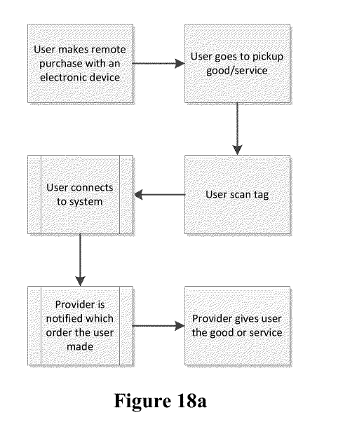

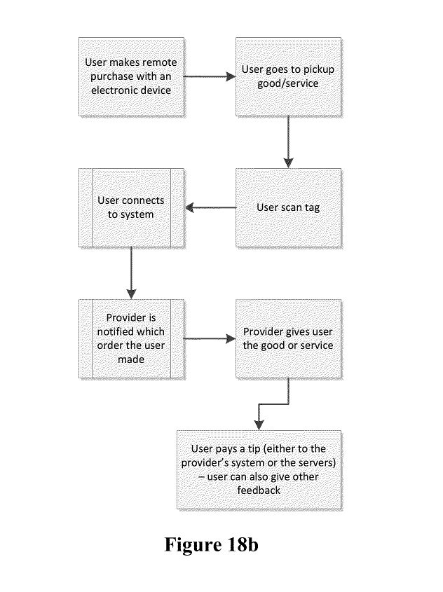

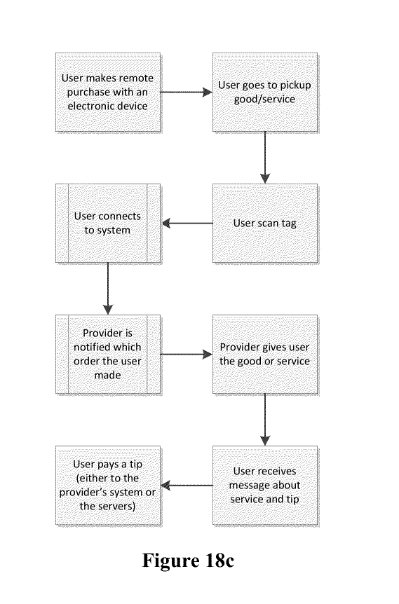

FIG. 18a is an illustration of a method for facilitating remote payment and pickup, according to the present invention. In this method, a user makes a remote purchase with an electronic device, remote could mean in the store or away from the store. Then the user gores to pick up the good and/or service. The user scans the tag with the mobile device and connects to the good/service provider system. The provider is then notified that user has already paid for the service during the remote purchase. The provider then renders the good and/or service.

FIG. 18b is an illustration of a method for facilitating remote payment and pickup, according to the present invention. In this method, the user sends an electronic payment tip after the good/service is rendered.

FIG. 18c is an illustration of a method for facilitating remote payment and pickup, according to the present invention. In this method, the user receives a message about the good/service that was rendered and the user sends an electronic payment tip after the good/service is rendered. Therefore, a provider could ask user to wait to see whether the user is satisfied with good or service and then send the user a message to evaluate the good/service and tip the provider (or employee) if the user is satisfied or believes a tip is warranted/deserving.

The details of this disclosure can be used for confirming that remote purchases for the goods and/or services are received. Therefore, a user can order something with an electronic device, not just mobile, and scan a tag when the user is receiving the good and or service. An example of this process is where the user orders a pizza using a mobile device (and mobile application) and pays for the pizza. The user then goes to the pizza place to pick up the pizza and scans a tag at the establishment. When the user scans the tag, the user connects to a system that notifies the establishment which order the user made and that payment was made. Although not required for this process, the user add a tip in addition to the payment for the pizza after receiving the pizza. The user may also be receive information from the provider and then give a tip. In addition, the user can provide additional comments to the user. Rewards programs can be combined with this method, as well as the other methods of this disclosure. This same process logically could be used to buy and pick-up goods at retail stores.

Although this disclosure covers a variety of ways to facilitate the described, the preferred embodiments use RFID tag and NFC enabled mobile devices. Furthermore, this disclosure may use authentication means, such as Biometric authentication, manual code input, or a user or device number (name, phone number, payment information, etc.).

The use of this disclosure for obtaining and returning items in not limited the examples explicitly listed herein. Other uses that follow the logic of a consumer obtaining an item and returning an item are contemplated and foreseeable. Tags used need not be the same type of tags. Therefore, embodiments may use more than one type of tag in configurations and processes. The step of a system receiving a user's information, including payment information for when the purchase/payment transaction is to be completed is a step that may be used in other embodiments in this disclosure. This holding of the purchase and/or payment information may occur whenever a user's mobile device is connected to a system or the user is identified by a tag scanner scanning a tag associated with the user.

The foregoing illustrations, embodiments, and examples are used in this disclosure to describe and convey the details of the present invention. These illustrations, embodiments, and examples do not represent an exhaustive list of embodiments and examples of the present invention. One of ordinary skill in the art may recognize that the described tag and mobile device interactions may be facilitated by different means, the interactions may use different configurations, or may contain more or less sets, processes, or components than explicitly listed in this disclosure. When referring to a tag in this disclosure, one of ordinary skill in the art may appreciate that a tag may be an RFID, printed code, QR code, barcode or any other code a person skilled in the art will recognize as a tag. One of the benefits of the inventions in this disclosure is the implementation of item specific tagging. In some preferred embodiments, RFID tags are used to store unique product identifies that are used in the embodied in this disclosure. The illustrations, embodiments, and examples of this disclosure, may include at least one tag and at least one mobile device, at least one system and at least one network. In some embodiments, a mobile device user may be required to connect to a specific network to access or enable functionality, including purchase a product or checkout a book. Furthermore, in some embodiments, a scanner may be substituted with other identification means, such as facial recognition.

When referring to a mobile device in this disclosure, one of ordinary skill in the art may appreciate that a mobile device may embody one or more phones, tablets, laptops or other devices that one skilled in the art would recognize as mobile devices. When referring to a network in this disclosure, one of ordinary skill in the art may appreciate that a network may include Wireless Internets, Mobile broadband, 4G, 3G, Wi-Fi, a computer network or any other type of network a person skilled in the art would recognize as a network for the purposes of this invention. When referring to a system in this disclosure, one of ordinary skill in the art may appreciate that a system may include a server, database, website or any other system formation one skilled in the art recognizes as a system. Furthermore, the directional indicators (arrows and lines) used in the figures are not meant to limit the direction in which an interaction or transfer occurs. It is contemplated and foreseeable that interactions may occur in a direct not expressly illustrated in the figures of this disclosure.

1. An apparatus comprising:
a location marking device;
a system; and
an electronic device.

2. A process comprising:
scanning a location marking device with an electronic device; and
communicating with a system.

3. A location marking device comprising information identifying the location, wherein the device enables a user to facilitate payment.
